(19) United States
(12) Patent Application Publication
(10) Pub. No.: US 2013/0009849 A1
(43) Pub. Date: Jan. 10, 2013

(54) PORTABLE WIRELESS DEVICE

(76) Inventors: Shuhhei Ohguchi, Osaka-shi (JP); Hiroyuki Takebe, Osaka-shi (JP)

(21) Appl. No.: 13/634,778

(22) PCT Filed: May 31, 2011
(86) PCT No.: PCT/JP2011/062541

§ 371 Date: Sep. 13, 2012

(30) Foreign Application Priority Data
Jun. 2, 2010 (JP) 2010-126791

(51) Int. Cl. H01Q 21/29

(52) U.S. Cl. 343/893

(57) ABSTRACT

It is possible to provide a mobile phone (10) including: a first feeding section (14); a first ground (15) for providing a reference potential to the first feeding section (14); a second feeding section (16); a second ground (17) for providing a reference potential to the second feeding section (16); a first transmission line via which the first feeding section (14) and the second ground (17) are electrically connected to each other; and a second transmission line via which the second feeding section (16) and the first ground (15) are electrically connected to each other. With the arrangement, it is possible to provide a portable wireless device having antennas employing excitation of bodies, which portable wireless device can reduce deterioration of antenna characteristics even in a case where one of the bodies is held in a hand.

### TECHNICAL FIELD

The present invention relates to a portable wireless device including an antenna which employs excitation of a body. Particularly, the present invention relates to a technique of reducing deterioration of antenna characteristics, which deterioration is caused in a case where a body is held in a hand.

### BACKGROUND ART

A mobile phone, which is a sort of portable wireless device, has been developed so as to have multiple functions.

With such development, there has been demand that the mobile phone has a smaller body and has a highly-integrated structure. In recent years, mobile phones having various structures have been developed. Among such mobile phones, a mainstream mobile phone is a foldable-type mobile phone having an upper body and a lower body. The foldable-type mobile phone has such a foldable arrangement that one of ends of the upper body and one of ends of the lower body are attached to each other rotatably and function as a hinge section. Further, other than such a foldable-type mobile phone, there have been (i) a slidable-type mobile phone having an arrangement in which an upper body and a lower body are coupled with each other slidably, and (ii) a straight body-type mobile phone which is constituted by a single body.

Among foldable-type mobile phones, there is such a mobile phone having a small body that (i) a conductive member constituting a hinge shaft of a hinge section serves as an antenna element and therefore (ii) it is unnecessary to provide an antenna element as an independent member (see Patent Literature 1, for example). The conductive member is electrically connected to one of the upper body and the lower body, and the one of the upper body and the lower body feeds the conductive member. Meanwhile, the conductive member is insulated from the other one of the upper body and the lower body. With the arrangement, it is possible to maintain good antenna characteristics without having no influence on the antenna characteristics due to an opening/closing operation of the other one of the upper body and the lower body.

Furthermore, there has been such a mobile phone that (i) a body itself serves as an antenna element and therefore (ii) the mobile phone has a small body. The body of the mobile phone has a large ground made from a metal, such as a ground pattern of a substrate and a frame of the body. By feeding a radio frequency signal from one of bodies to a ground of the other one of bodies, it is possible to excite the other one of bodies. It is thus possible to employ the other one of bodies it self as an antenna element.

### CITATION LIST

### Patent Literature

Patent Literature 1
Japanese Patent Application Publication, Tokukai, No. 2007-88692 A (Publication Date: Apr. 5, 2007)

### SUMMARY OF INVENTION

### Technical Problem

However, a conventional mobile phone (portable wireless device) having an antenna which employs excitation of a body (like the mobile phone described above) has a problem that, in a case where a body to which a radio frequency signal is fed, i.e., a part serving as an antenna element, is held in a hand, antenna characteristics of the mobile phone are significantly deteriorated. A mobile phone in use generally receives an electric wave while being held in a hand. For this reason, it is necessary to have a countermeasure against the deterioration of antenna characteristics.

The present invention is made in view of the conventional problems. An object of the present invention is to provide a portable wireless device which (i) has such an antenna that a radio frequency signal is fed to a ground, e.g., an arrangement in which excitation of a body is employed, and (ii) can reduce deterioration of antenna characteristics even in a case where a part in the vicinity of the ground is held in a hand.

### Solution to Problem

In order to attain the object, a portable wireless device of the present invention includes: a first feeding section; a first ground for providing a reference potential to the first feeding section; a second feeding section; a second ground for providing a reference potential to the second feeding section; a first transmission line via which the first feeding section and the second ground are electrically connected to each other; and a second transmission line via which the second feeding section and the first ground are electrically connected to each other.

With the arrangement, the second feeding section feeds a radio frequency signal to the first ground so as to excite the first ground. This makes it possible to cause the first ground to serve as an antenna element (first antenna). Further, the first feeding section feeds radio frequency signal to the second ground, so as to excite the second ground. This makes it possible to cause the second ground to serve as an antenna element (second antenna).

Furthermore, in a case where (i) the first antenna and the second antenna are simultaneously in operation and (ii) a part in the vicinity of the first ground is held in a hand, deterioration of antenna characteristics of the second antenna is less than deterioration of antenna characteristics of the first antenna. Meanwhile, in a case where (i) the first antenna and the second antenna are simultaneously in operation and (ii) a part in the vicinity of the second ground is held in a hand, deterioration of antenna characteristics of the first antenna is less than deterioration of antenna characteristics of the second antenna. For these reasons, even in a case where any one of the part in the vicinity of the first ground and the part in the vicinity of the second ground is held in a hand, it is possible to reduce deterioration of antenna characteristics of the entire portable wireless device, particularly, by use of a diversity technique, for example.

Accordingly, with the portable wireless device having the arrangement in which a radio frequency signal is fed to the grounds and therefore the first antenna and the second antenna are realized, it is possible to reduce deterioration of antenna characteristics even in a case where any one of the parts in the vicinity of the grounds is held in a hand. Moreover, in order to attain the object, a portable wireless device of the present invention can include: a first feeding section; a first ground for providing a reference potential to the first feeding section; a second feeding section; a second ground for providing a reference potential to the second feeding section; and a transmission line having a first terminal and a second terminal, the first terminal of the transmission line being electrically connected to, via a first branch point provided between the first terminal and the second terminal, both the first feeding section and the first ground, the second terminal of the transmission line being electrically connected to, via a second branch point provided between the first branch point and the second terminal, both the second feeding section and the second ground.

With the arrangement, it becomes possible to prevent (i) the first feeding section from feeding a radio frequency signal to the first ground and (ii) the second feeding section from feeding radio frequency signal to the second ground by (I) separating a signal by use of an impedance having a frequency characteristic or (II) switching a signal by use of a switch.

Accordingly, it becomes possible to feed radio frequency signal from the second feeding section to the first ground via the transmission line. This makes it possible to excite the first ground so as to cause the first ground to serve as an antenna element (first antenna). Further, it becomes possible to feed a radio frequency signal from the first feeding section to the second ground via the transmission line. This makes it possible to excite the second ground so as to cause the second ground to serve as an antenna element (second antenna).

Accordingly, even in a case where a single transmission line is shared, it is possible to cause the first antenna and the second antenna to operate successfully with either (i) a single frequency or (ii) different frequencies, respectively. Further, since only a single transmission line is required, it is possible to have a simple arrangement of the single transmission line, as compared with a case where a plurality of transmission lines are employed.

Moreover, in a case where (i) the first antenna and the second antenna are in operation simultaneously and (ii) a pert in the vicinity of the first ground is held in a hand, deterioration of antenna characteristics of the second antenna is less than deterioration of antenna characteristics of the first antenna. Meanwhile, in a case where (i) the first antenna and the second antenna are in operation simultaneously and (ii) a part in the vicinity of the second ground is held in a hand, deterioration of antenna characteristics of the first antenna is less than deterioration of antenna characteristics of the second antenna. Accordingly, in a case where any one of the part in the vicinity of the first ground and the part in the vicinity of the second ground is held in a hand, it is possible to reduce antenna characteristics of the entire portable wireless device, particularly, by use of a diversity technique, for example.

Accordingly, with the portable wireless device having an arrangement in which a radio frequency signal is fed to the grounds and therefore the first antenna and the second antenna are realized, it is possible to reduce deterioration of antenna characteristics even in a case where any one of the parts in the vicinity of grounds is held in a hand.

### Advantageous Effects of Invention

As described above, a portable wireless device of the present invention includes: a first feeding section; a first ground for providing a reference potential to the first feeding section; a second feeding section; a second ground for providing a reference potential to the second feeding section; a first transmission line via which the first feeding section and the second ground are electrically connected to each other; and a second transmission line via which the second feeding section and the first ground are electrically connected to each other.

Accordingly, with an arrangement in which the first antenna and the second antenna are realized by use of the grounds, it is possible to reduce deterioration of antenna characteristics even in a case where any one of parts in the vicinity of the grounds is held in a hand.

### BRIEF DESCRIPTION OF DRAWINGS

FIG. 1 is a view schematically illustrating a portable wireless device in accordance with an embodiment of the present invention.

FIG. 2 is a view schematically illustrating an example of an arrangement in the vicinity of a body coupling section of the portable wireless device, to which a capacitive feeding technique is applied: (a) of FIG. 2 is a view illustrating the portable wireless device which (i) is in an open state and (ii) is viewed in a front direction; and (b) of FIG. 2 is a view illustrating a cross-section of the portable wireless device which (i) is in the open state and (ii) is viewed in a lateral direction.

FIG. 3 is a view schematically illustrating an example of an arrangement in the vicinity of a body coupling section of the portable wireless device, to which a direct feeding technique is applied: (a) of FIG. 3 is a view illustrating the portable wireless device which (i) is in a closed state and (ii) is viewed in a front direction; and (b) of FIG. 3 is an enlarged view illustrating an arrangement in the vicinity of the body coupling section.

FIG. 4 is a view schematically illustrating another example of the arrangement in the vicinity of the body coupling section of the portable wireless device to which the direct feeding technique is applied.

FIG. 5 is a block diagram illustrating an example of a communication system of the portable wireless device, which communication system has an arrangement in which both a first antenna and a second antenna are connected to a single tuner.

FIG. 6 is a block diagram illustrating an example of a communication system of the portable wireless device, which communication system has an arrangement in which a first antenna and a second antenna are connected to different tuners, respectively.

FIG. 7 is a view schematically illustrating a portable wireless device in accordance with another embodiment of the present invention.

FIG. 8 is a view schematically illustrating a portable wireless device in accordance with further another embodiment of the present invention.

FIG. 9 is a view schematically illustrating another a portable wireless device in accordance with further another embodiment of the present invention.

FIG. 10 is a view schematically illustrating a portable wireless device in accordance with further another embodiment of the present invention.

FIG. 11 is a view schematically illustrating a portable wireless device in accordance with further another embodiment of the present invention.

FIG. 12 is a view schematically illustrating a portable wireless device in accordance with further another embodiment of the present invention.

FIG. 13 is a view schematically illustrating a portable wireless device in accordance with further another embodiment of the present invention.

### DESCRIPTION OF EMBODIMENTS

Embodiments of the present invention are described below. Each of the embodiments is explained in such a manner that a mobile phone is used as an example of a portable wireless device of the present invention. Note, however, that the portable wireless device of the present invention is not limited to a mobile phone, and may be a portable wireless device which includes a TV but does not have a telephone function, or a PDA having a wireless communication function, for example.

### Embodiment 1

One embodiment of the present invention is described below with reference to drawings.

(Arrangement of Mobile Phone)

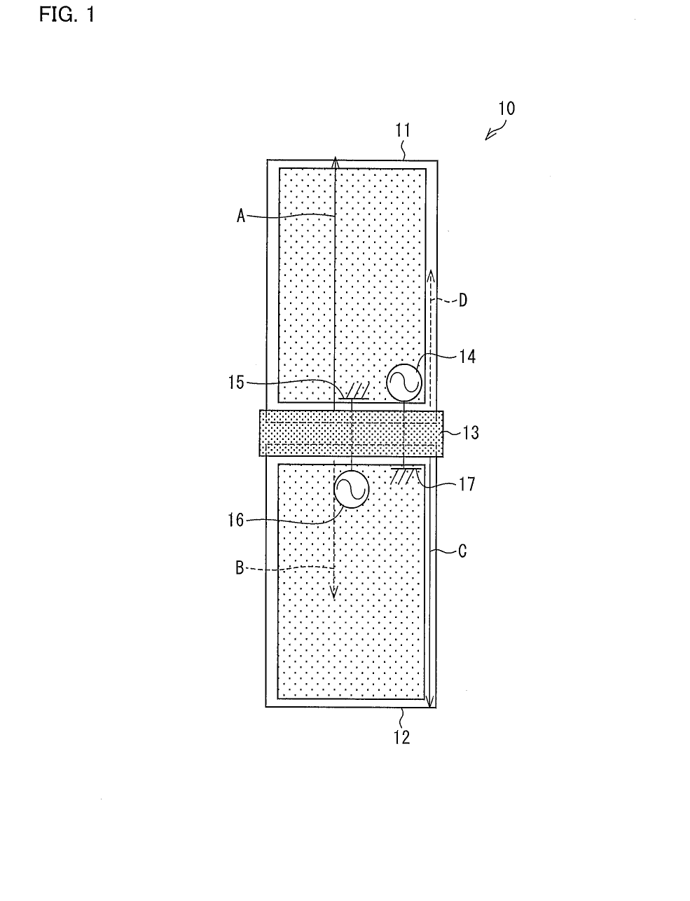

FIG. 1 is a view schematically illustrating an example of an arrangement of a mobile phone 10 of the present embodiment.

The mobile phone 10 (portable wireless device) of the present embodiment includes a first body 11, a second body 12, and a body coupling section 13 (see FIG. 1). The body coupling section 13 is a part (hinge structure) via which one of ends of the first body 11 and one of ends of the second body 12 are coupled with each other rotatably. The first body 11 and the second body 12 are coupled with each other via the body coupling section 13 so as to be rotatable forward and backward. That is, the mobile phone 10 is a foldable-type device in which the first body 11 and the second body 12 can rotate forward and backward by using the body coupling section 13 as an axis of rotation.

In the first body 11 and the second body 12, components of the mobile phone 10 are provided. The first body 11 includes a first feeding section 14. The second body 12 includes a second feeding section 16. Further, in the other part (not illustrated) of the first body 11 and in the other part (not illustrated) of the second body 12, general components of a mobile phone are provided appropriately. Here, for example, the first body 11 includes a display section, a speaker, an image-capturing element for a camera, and a circuit substrate (any one of which is not illustrated in FIG. 1). The second body 12 includes an operation key via which key input is carried out, a microphone, a control section, and a circuit substrate (any one of which is not illustrated in FIG. 1), for example.

The first body 11 and the second body 12 can be made from a resin or a metal. Further, the first body 11 and the second body 12 can be provided with or integrated with a metallic frame (a frame made from magnesium (Mg), for example). Furthermore, a metallic reinforcing member (made from stainless steel (SUS) or aluminum (Al), for example) can be added to the first body 11 and the second body 12.

Moreover, the first body 11 includes a first ground 15 which provides a reference potential (ground potential) to (i) a wireless circuit provided in the first body 11 and (ii) the first feeding section 14. The first ground 15 may be a ground pattern of a circuit substrate provided in the first body 11, a metallic frame of the first body 11, a metallic reinforcing member for reinforcing the first body 11, or a ground pattern of a liquid crystal panel attached to the first body 11, for example. The second body 12 includes a second ground 17 which provides a reference potential (ground potential) to (i) a wireless circuit provided in the second body 12 and (ii) the second feeding section 16 provided in the second body 12. The second ground 17 may be a ground pattern of a circuit substrate provided in the second body 12, a metallic frame of the second body 12, a metallic reinforcing member (made from SUS or aluminum, for example) for reinforcing the second body 12, or a shield case, for example.

The first feeding section 14 is provided in the first body 11, and is electrically connected to the second ground 17 via a transmission line (first transmission line) provided in the body coupling section 13. With the arrangement, a radio frequency signal is fed from the first feeding section 14 to the second ground 17. The first feeding section 14 is electrically connected to the wireless circuit (not illustrated) which has an arrangement in accordance with a function of the communication system.

The second feeding section 16 is provided in the second body 12, and is electrically connected to the first ground 15 via another transmission line (second transmission line) provided in the body coupling section 13. With the arrangement, a radio frequency signal is fed from the second feeding section 16 to the first ground 15. Further, the second feeding section 16 is electrically connected to the wireless circuit (not illustrated) which has an arrangement in accordance with a function of the communication system.

Note that a connection between the transmission line and the first feeding section 14, a connection between the transmission line and the second ground 17, a connection between the another transmission line and the first ground 15, and a connection between the another transmission line and the second feeding section 16 can be direct coupling (DC) or high-frequency coupling (RF) (such as capacitive coupling).

Further, each of the wireless circuits can be provided either in the first body 11 or in the second body 12. For example, it is possible that (i) the wireless circuits are provided respectively in the first body 11 and the second body 12, or (ii) the wireless circuits are provided in one of the first body 11 or in the second body 12. Further, depending on a function of the communication system, there is a case where only a single wireless circuit is provided. In this case, the single wireless circuit can be provided either in the first body 11 or in the second body 12. In the present specification, the “wireless circuit” means a circuit which includes not only a circuit section for realizing a sending/receiving function but also a matrix calculation section, a control section, and the like. The “wireless circuit” can be realized by use of a conventional circuit configuration (e.g., a circuit for a cellular communication system), for example, and is provided on a circuit substrate.

(Principle of Operation of Antenna by Employing Excitation of Body)

The mobile phone 10 having the arrangement described above can cause the first body 11 to serve as an antenna element, and also can cause the second body 12 to serve as an antenna element. Next, the following description deals with a principle of how such an antenna element operates, with reference to FIG. 1. Note that the following explanation deals with a case where a difference between a length of the mobile phone 11 in a vertical direction (a longitudinal direction of the mobile phone 10 in FIGS. 1) and λ/4 of a used frequency is less than a difference between a length of the mobile phone 11 in a horizontal direction (a direction of a short side of the mobile phone 10 in FIGS. 1) and λ/4 of the used frequency.

The second feeding section 16 feeds a radio frequency signal to the first ground 15, so that a current flows in a direction indicated by an arrow A in FIG. 1 (a current flowing through the first body 11 (arrow A) > a current flowing through the second body 12 (arrow B)). This excites the first ground 15, so that (i) the first ground 15 serves as an antenna element, and therefore (ii) antenna characteristics of the entire first body 11 are ensured. It is thus possible to cause the first body 11 to serve as an antenna element.

The first feeding section 14 feeds a radio frequency signal to the second ground 17, so that a current flows in a direction indicated by an arrow C in FIG. 1 (a current flowing through the first body 11 (arrow D) > a current flowing through the second body 12 (arrow C)). This excites the second ground 17, so that (i) the second ground 17 serves as an antenna element, and therefore (ii) antenna characteristics of the entire second body 12 are ensured. It is thus possible to cause the second body 12 to serve as an antenna element.

Accordingly, the mobile phone 10 can have two antennas, each employing excitation of a corresponding body, in such a manner that (i) one feeding point is provided in each of the bodies and (ii) a radio frequency signal is fed from the feeding point provided in one of the bodies to the other one of the bodies. Hereinafter, an antenna realized by the first body 11 is referred to as “first antenna”, and an antenna realized by the second body 12 is referred to as “second antenna”.

Note that it is preferable that the first ground 15 has a large area and the second ground 17 has a large area. Ideally, the first ground 15 is provided throughout the first body 11, and the second ground 17 is provided throughout the second body 12. The larger an area of the first ground 15 and an area of the second ground 17 become, the more easily the first body 11 and the second body 12 can be used as antennas.

(How to Feed Radio Frequency Signal)

Next, the following description deals with how to feed a radio frequency signal to each of the bodies of the mobile phone 10. A capacitive feeding technique or a direct feeding technique can be applied to the mobile phone 10, for example.

(1) Capacitive Feeding

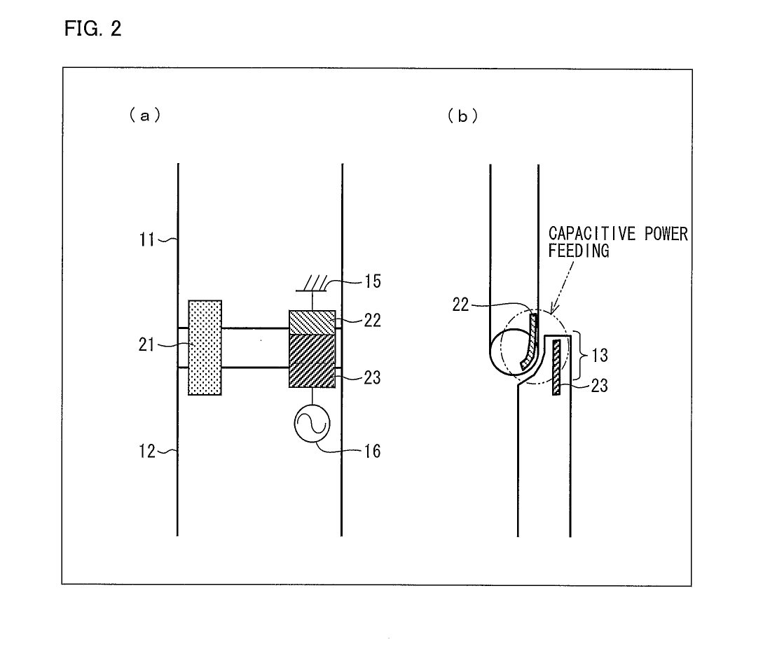

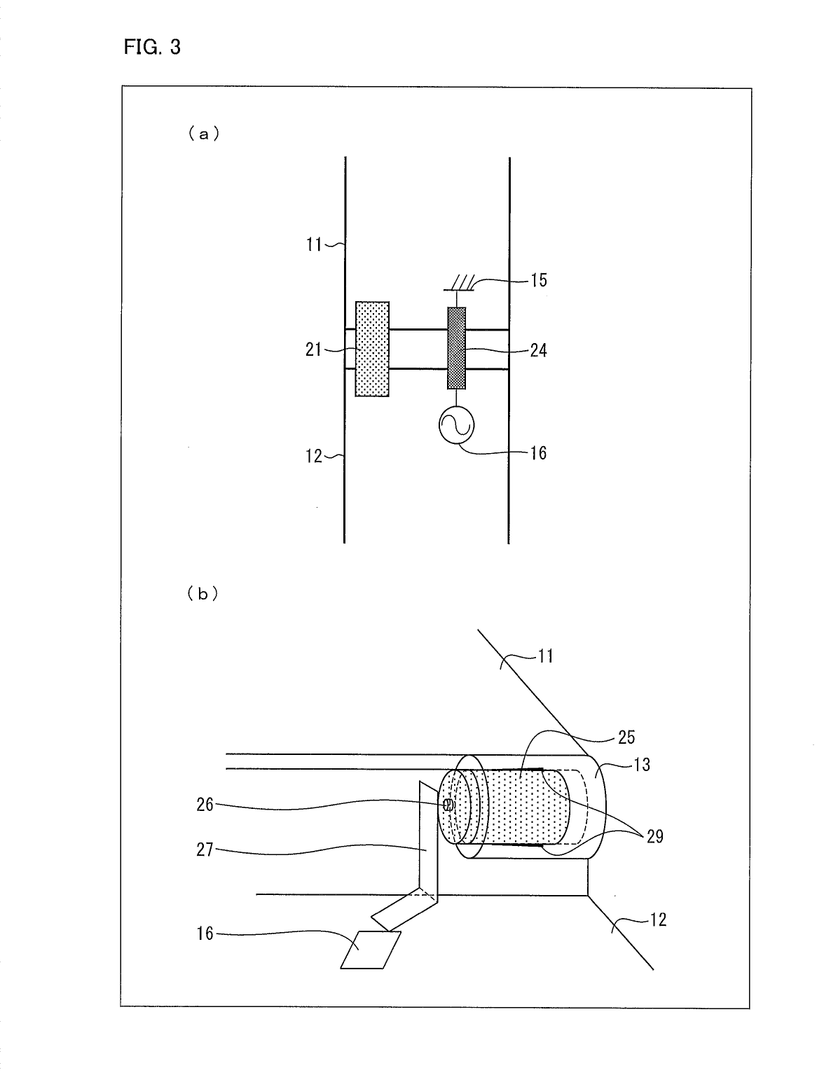

FIG. 2 is a view schematically illustrating an example of an arrangement in the vicinity of the body coupling section 13 of the mobile phone 10 to which the capacitive feeding technique is applied. (a) of FIG. 3 is a view illustrating the mobile phone 10 which (i) is in an open state and (ii) is viewed in a front direction. (b) of FIG. 3 is a view illustrating the mobile phone 10 which (i) is in the open state and (ii) is viewed in a lateral direction.

As illustrated in FIG. 2, the body coupling section 13 is constituted by a part in which one of ends of the first body 11 and one of ends of the second body 12 overlap each other. At the body coupling section 13, the first body 11 is provided with a first feeding pad 22, and the second body 12 is provided with a second feeding pad 23. The first feeding pad 22 is electrically connected to the first ground 15. The second feeding pad 23 is electrically connected to the second feeding section 16.

The first feeding pad 22 and the second feeding pad 23 are made from a conductive material. The first feeding pad 22 and the second feeding pad 23 are provided so that there is a gap between the first feeding pad 22 and the second feeding pad 23. Accordingly, the first feeding pad 22 and the second feeding pad 23 are not electrically connected to each other directly. However, in a case where the first body 11 and the second body 12 become in the open state, the first feeding pad 22 and the second feeding pad 23, facing each other, are coupled with each other via an electrostatic capacitance which is determined on the basis of (i) areas of the first feeding pad 22 and the second feeding pad 23 and (ii) a distance between the first feeding pad 22 and the second feeding pad 23. That is, the first feeding pad 22 and the second feeding pad 23 are high-frequency coupled with (electrically connected to) each other. It becomes thus possible to feed a radio frequency signal.

(2) Direct Feeding

FIG. 3 is a view schematically illustrating an example of an arrangement in the vicinity of the body coupling section 13 of the mobile phone 10 to which the direct feeding technique is applied. (a) of FIG. 3 is a view illustrating the mobile phone 10 which (i) is in the open state and (ii) is viewed in a front direction. (b) of FIG. 3 is an enlarged view illustrating an arrangement in the vicinity of the body coupling section 13.

As illustrated in (a) of FIG. 3, a conductor 24 is provided so as to connect, directly, the first ground 15 of the first body 11 and the second feeding section 16 of the second body 12 to each other. The conductor 24 is arranged so as to extend, through inside the body coupling section 13, from the first body 11 to the second body 12. The conductor 24 is constituted by conductive members. The conductor 24 may be a coaxial cable, a sheet metal, or a conductive hinge, for example.

Here, (b) of FIG. 3 illustrates an example of an arrangement in which the conductor 24 is constituted by a conductive hinge 25 and a spring sheet metal 27. The conductive hinge 25 has a shape of a circular column, and a projection part 26 is provided on one of end surfaces of the conductive hinge 25 (see (b) of FIG. 3). The conductive hinge 25 is provided in a hole of the body coupling section 13 in such a manner that the projection part 26 is in contact with the spring sheet metal 27. The conductive hinge 25 has a conductive hinge spring part 29 which has a spring characteristic. The conductive hinge spring part 29 is electrically connected to the body coupling section 13. With the arrangement, the conductive hinge 25 is electrically connected to the first ground 15 of the first body 11. The spring sheet metal 27 is electrically connected to the second feeding section 16 of the second body 12. Accordingly, the first ground 15 and the second feeding section 16 are electrically connected to each other directly.

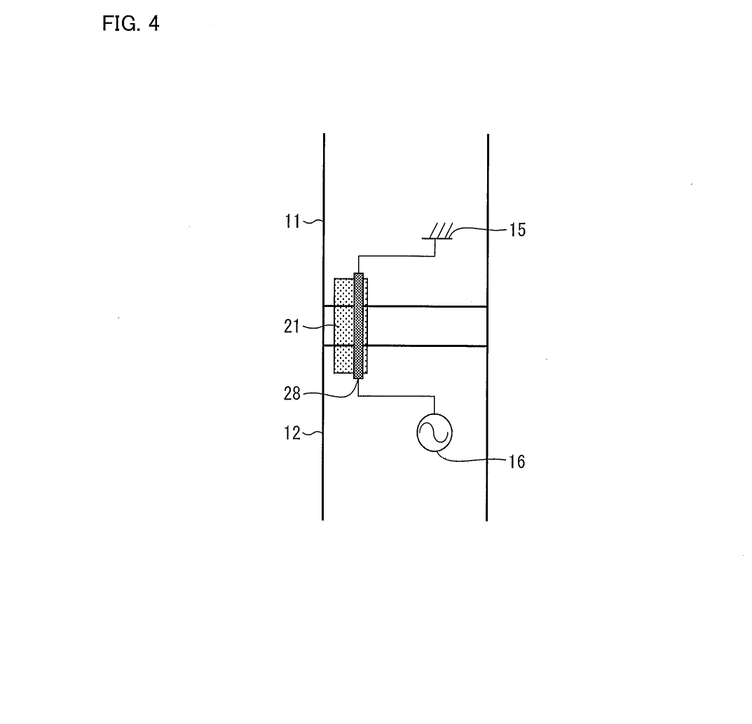

Further, FIG. 4 illustrates another example of the arrangement of the conductor 24. In the example illustrated in FIG. 4, a feeding pattern 28 is provided to extend through a body connection section 21 which is constituted by a flexible substrate, a coaxial fine line, and/or the like.

The body connection section 21 makes an electrical connection of a circuit substrate provided in the first body 11, another circuit substrate provided in the second body 12, grounds, and the like. The mobile phone 10 can include the body connection section 21, if necessary. The body connection section 21 is arranged so as to extend, through the body coupling section 13, from the first body 11 to the second body 12. The body connection section 21 may be a flexible wiring or a coaxial fine line, for example. The feeding pattern 28 may be added to the body connection section 21, or may be formed integral with the body connection section 21.

The above explanation made with reference to drawings deals with how to feed a radio frequency signal from a second body 12 side to a first body 11 side, for the sake of simple explanation. Note, however, that such a technique can be also applied to feed a radio frequency signal from the first body 11 side to the second body 12 side as well. That is, in a case where the capacitive feeding technique is applied, a transmission line constituted by the first feeding pad 22 and the second feeding pad 23 is provided to feed a radio frequency signal from the first feeding section 14 to the second ground 17. The transmission line causes (i) the first feeding pad 22 to be connected to the first feeding section 14 electrically, and (ii) the second feeding pad 23 to be connected to the second ground 17 electrically. In a case where the direct feeding technique is applied, a transmission line constituted by the conductor 24 is provided to feed a radio frequency signal from the first feeding section 14 to the second ground 17. The transmission line constituted by the conductor 24 causes the first feeding section 14 and the second ground 17 to be electrically connected to each other directly.

Further, a technique of feeding a radio frequency signal from the first body 11 side to the second body 12 and a technique of feeding a radio frequency signal from the second body 12 side to the first body 11 side can be either (i) identical with each other or (ii) different from each other. For example, it is possible to have an arrangement in which (i) the transmission line (first transmission line) between the first feeding section 14 and the second ground 17 is made by use of the capacitive feeding technique and (ii) the transmission line (second transmission line) between the second feeding section 16 and the first ground 15 is made by use of the direct feeding technique, or vice versa.

Furthermore, examples of how to feed a radio frequency signal are not limited to the capacitive feeding technique and the direct feeding technique, and it is possible to employ another feeding technique. For example, it is possible to have an arrangement in which (i) one of the first transmission line and the second transmission line is made by use of the capacitive feeding technique (an arrangement in which an input side and an output side are capacitively high-frequency coupled with each other capacitively) and (ii) the other one of the first transmission line and the second transmission line is made by use of a feeding technique which is neither the capacitive feeding technique nor the direct feeding technique. Moreover, it is possible to have an arrangement in which (i) one of the first transmission line and the second transmission line is made by use of the direct feeding technique (an arrangement in which the input side and the output side are electrically connected to each other directly) and (ii) the other one of the first transmission line and the second transmission line is made by use of a feeding technique which is neither the capacitive feeding technique nor the direct feeding technique.

(Communication System)

As described above, the mobile phone 10 is such that the first body 11 serves as the first antenna, and the second body 12 serves as the second antenna. Here, the following description deals with a communication system of the mobile phone 10, which communication system employs the first antenna and the second antenna.

In addition to a communication function of a mobile phone, the mobile phone 10 can have other functions (such as a TV viewing function and a GPS function), if necessary. Accordingly, either the first antenna or the second antenna of the mobile phone 10 can be also used as an antenna of a wireless communication section for realizing such functions.

Further, the first antenna and the second antenna can be used either in a single communication system or in different communication systems, respectively. Furthermore, the first antenna and the second antenna can be used with a diversity technique, a switching technique, or MIMO (Multiple Input Multiple Output).

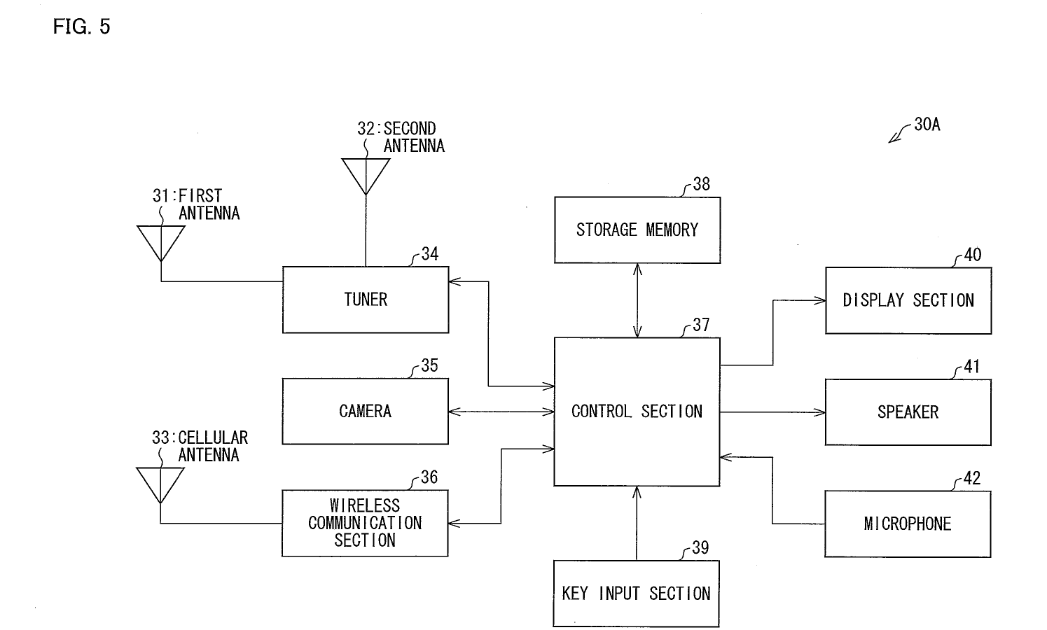

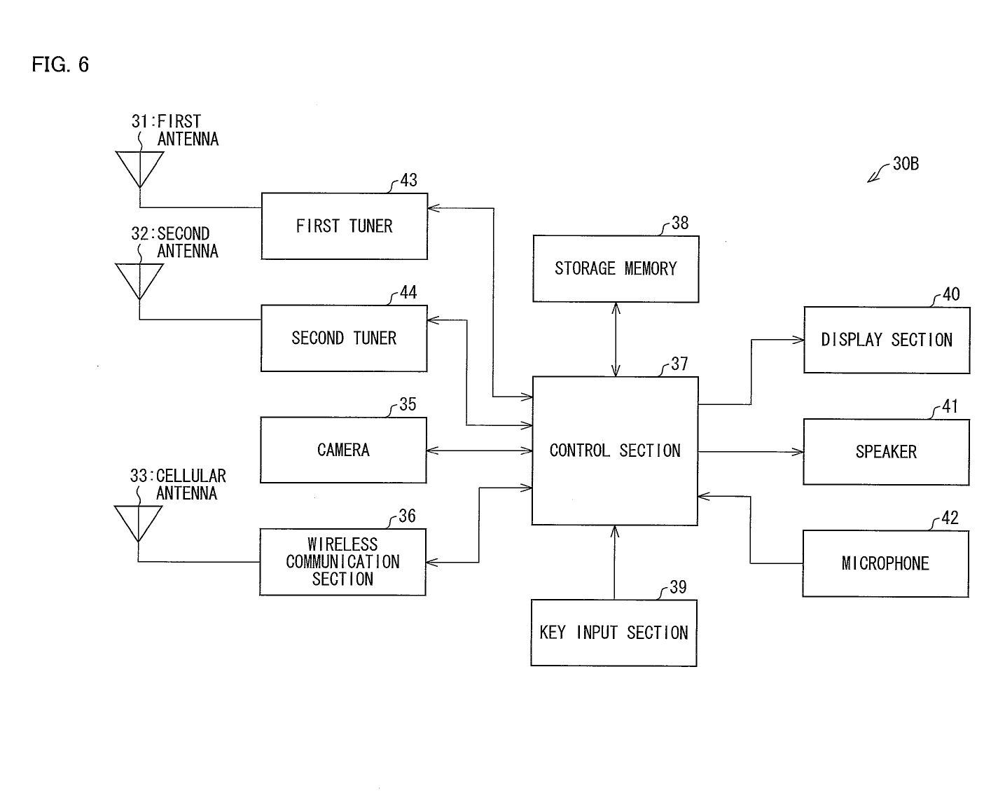

Here, as an example of the communication system of the mobile phone 10, each of FIGS. 5 and 6 illustrates a communication system in which the first antenna and the second antenna are used as receive-only antennas for receiving, for example, a digital broadcast. Note that, in a case where the first antenna and the second antenna are used to realize functions other than a mobile phone function, the mobile phone 10 includes another antenna for realizing the mobile phone function. As described above, the mobile phone 10 can include an antenna other than the first antenna and the second antenna, depending on desired functions of the mobile phone 10.

FIG. 5 is a block diagram illustrating an arrangement of a communication system 30A in which the first antenna and the second antenna are connected to a single tuner. The communication system 30A includes a first antenna 31, a second antenna 32, a cellular antenna 33, a tuner 34, a camera 35, a wireless communication section 36, a control section 37, a storage memory 38, a key input section 39, a display section 40, a speaker 41, and a microphone 42 (see FIG. 5). For example, the camera 35, the display section 40, and the speaker 41 are provided in the first body 11, and the tuner 34, the wireless communication section 36, the control section 37, the storage memory 38, the key input section 39, and the microphone 42 are provided in the second body 12. Note, however, that the present invention is not limited to this.

The control section 37 is electrically connected to the tuner 34, the camera 35, the wireless communication section 36, the storage memory 38, the key input section 39, the display section 40, the speaker 41, and the microphone 42. The control section 37 carries out, with respect to the tuner 34, the camera 35, and the wireless communication section 36, (i) drive control, and (ii) interactive transmission/reception of a signal, for example. Further, the control section 37 controls (i) an input operation carried out with respect to the key input section 39, (ii) a display operation of the display section 40, (iii) an audio output from the speaker 41, and (iv) an audio input received by the microphone 42, for example. Moreover, the control section 37 controls the storage memory 38 to store data/signal, and read out the data/signal from the storage memory 38, for example.

The cellular antenna 33 is a sending/receiving antenna for a mobile phone. The cellular antenna 33 can be provided either in the first body 11 or in the second body 12, and is electrically connected to the wireless communication section 36. The wireless communication section 36 feeds a radio frequency signal to the cellular antenna 33 so that the cellular antenna 33 carries out transmission/reception of an electric wave. The cellular antenna 33 may be a multiband antenna which can resonate with a GSM (Global System for Mobile communications: 900 MHz) band, a DSC (Digital Cellular Systems: 1.8 GHz) band, a PCS (Personal Communication Services: 1.9 GHz) band, a WCDMA (Wideband Code Division Multiple Access: 2 GHz) band, and the like. Alternatively, the cellular antenna 33 may be an antenna which resonates with one frequency band.

The first antenna 31 is realized in such a manner that the first body 11 (first ground 15) is used as an antenna element. The second antenna 32 is realized in such a manner that the second body 12 (second ground 17) is used as an antenna element. Both the first antenna 31 and the second antenna 32 are electrically connected to the tuner 34. The first antenna 31 and the second antenna 32 can be antennas which resonate with a UHF (Ultra High Frequency: from 470 MHz to 770 MHz) band.

The mobile phone 10 having the communication system 30A can successfully receive an electric wave (digital broadcast signal) by use of a diversity technique, a switching technique, or MIMO, for example.

FIG. 6 is a block diagram illustrating an arrangement of a communication system 30B in which the first antenna and the second antenna are connected to different tuners, respectively. The communication system 30B illustrated in FIG. 6 is such that, in the arrangement of the communication system 30A illustrated in FIG. 5, a first tuner 43 and a second tuner 44 are provided in place of the tuner 34. In the communication system 30B, the first antenna 31 is electrically connected to the first tuner 43, and the second antenna 32 is electrically connected to the second tuner 44.

The mobile phone 10 having the communication system 30B has the two tuners (the first tuner 43 and the second tuner 44), and therefore can decode simultaneously digital broadcast signals of different channels. Accordingly, it becomes possible to, for example, (i) divide a display region of the display section 40 into a plurality of divisional display regions, and (ii) cause the plurality of divisional display regions to display simultaneously broadcast videos of different channels, respectively.

Note that the frequency bands with which the first antenna 31, the second antenna 32, and the cellular antenna 33 resonate are not limited to the frequency bands described above, and can be changed depending on a spec of the communication system, if necessary. It is possible that the first antenna 31, the second antenna 32, and the cellular antenna 33 resonate with frequency bands other than the frequency bands described above.

As described above, the mobile phone 10 includes the first body 11, the second body 12, and the body coupling section 13 via which the first body 11 and the second body 12 are coupled with each other. The first body 11 and the second body 12 are coupled with each other so as to be rotatable forward and backward by using the body coupling section 13 as an axis of rotation. The first body 11 includes the first feeding section 14 and the first ground 15. The second body 12 includes the second feeding section 16 and the second ground 17. The body coupling section 13 includes two transmission lines. The first feeding section 14 is electrically connected to the second ground 17 via one of the two transmission lines. The second feeding section 16 is electrically connected to the first ground 15 via the other one of the two transmission lines.

According to the arrangement, the second feeding section 16 feeds a radio frequency signal to the first ground 15, so as to excite the first ground 15. This makes it possible to cause the first ground 15, (i.e., the first body 11) to serve as an antenna element (first antenna). Further, the first feeding section 14 feeds a radio frequency signal to the second ground 17, so as to excite the second ground 17. This makes it possible to cause the second ground 17 (i.e., the second body 12) to serve as an antenna element (second antenna).

Furthermore, in a case where (i) the first antenna and the second antenna are in operation simultaneously and (ii) the first body 11 is held in a hand, deterioration of antenna characteristics of the second antenna is less than deterioration of antenna characteristics of the first antenna. Meanwhile, in a case where (i) the first antenna and the second antenna are in operation simultaneously and (ii) the second body 13 is held in a hand, the deterioration of antenna characteristics of the first antenna is less than the deterioration of antenna characteristics of the second antenna. Accordingly, even in a case where any one of the first body 11 and the second body 12 is held in a hand, it is possible to reduce deterioration of antenna characteristics of the entire mobile phone 10, particularly, by employing the diversity technique, for example.

Accordingly, the mobile phone 10 including the first antenna and the second antenna, each employing excitation of a corresponding one of the first body and the second body, can reduce deterioration of antenna characteristics, even if the first body 11 or the second body 12 is held in a hand.

Moreover, positions of the first antenna 11 and the second antenna 12 are different from each other, regardless of both the first body 11 and the second body 12 are held in a hand or the mobile phone 10 itself is not in contact with a hand. Since the positions of the first antenna 11 and the second antenna 12 are different from each other, it is possible to employ spatial diversity. Accordingly, it is possible to reduce deterioration of antenna characteristics, as compared with a conventional arrangement.

Note that, when the first antenna and the second antenna are used, there is no limitation in direction in which the mobile phone 10 is oriented. For example, the mobile phone 10 can be used such that the first body 11 including the display section is in an upper position, and the second body 12 is in a lower position (vertical orientation). Further, in a case where a TV broadcast is viewed on the mobile phone 10, the mobile phone 10 can be used such that the first body 11 is in a left position, and the second body 12 is in a right position (horizontal orientation). Regardless of (i) which direction the mobile phone 10 is oriented in and (ii) how the mobile phone 10 is held in a hand, it is possible for the mobile phone 10 to have a reduction in deterioration of antenna characteristics.

Further, the mobile phone 10 has such a foldable structure that the first body 11 and the second body 12 can rotate forward and backward by use of the body coupling section 13 as an axis of rotation. Note, however, that the present invention is not limited to this. For example, it is possible that the mobile phone 10 has what is called a slidable structure, as long as a constant distance is ensured between the first antenna and the second antenna.

### Modified Example

The above explanation is made on mainly a premise that both antennas (the first antenna and the second antenna) are used as receiving antennas. Note, however, that the present invention is not limited to this. For example, it is possible that one of the antennas (the first antenna and the second antenna) is used as a sending antenna or a sending/receiving antenna.

Note that, in a case where the first antenna (first ground 15) or the second antenna (second ground 17) is used as a receiving antenna, the mobile phone 10 has an arrangement in which a signal received by the first antenna or the second antenna is transmitted to a baseband section (such as a control section) via a tuner, and then is processed by the baseband section, for example. Further, in a case where the first antenna or the second antenna is used as a sending antenna, the mobile phone 10 has an arrangement in which (i) a signal generated by the baseband section is converted into an RF signal by use of a wireless circuit, (ii) the RF signal is supplied to each of the antennas via a feeding section, and (iii) the RF signal is transmitted.

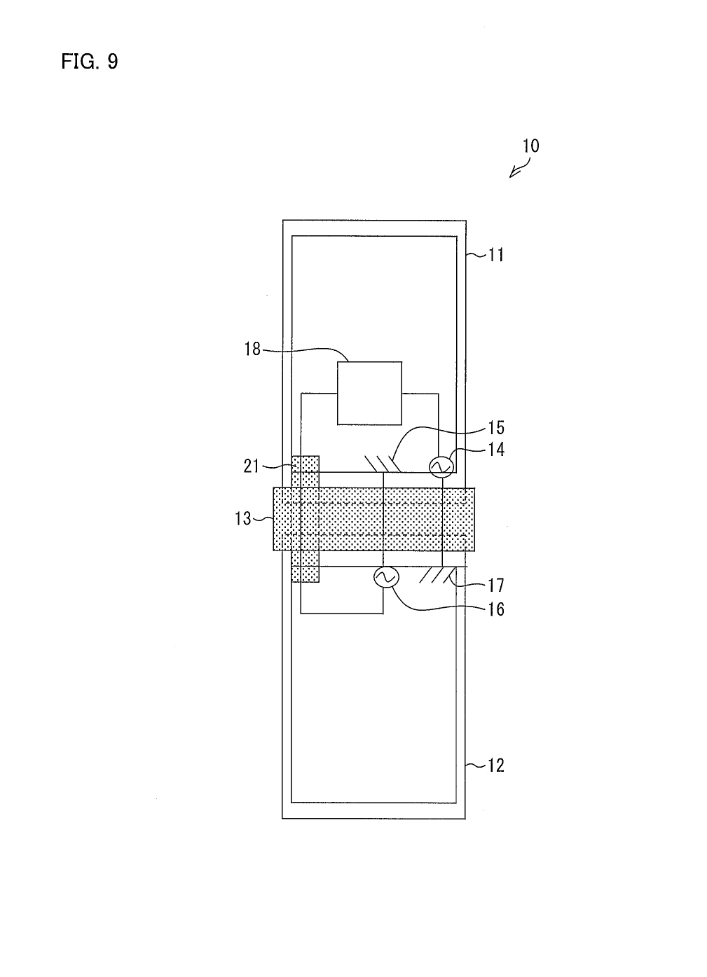

Moreover, the first feeding section 14 and the second feeding section 16 can be connected to either (i) different wireless circuits, respectively, or (ii) a single wireless circuit. FIG. 9 is a view schematically illustrating an example of an arrangement in which both the first feeding section 14 and the second feeding section 16 are connected to a single wireless circuit 18.

According to the arrangement illustrated in FIG. 9, the first feeding section 14 is connected to, via a substrate pattern, a coaxial cable, and/or the like, the wireless circuit 18 provided in the first body 11. Further, the second feeding section 16 is connected to, via a body connection section 21 constituted by a coaxial cable, a flexible cable, or the like, the wireless circuit 18 provided in the first body 11. It is thus possible that the mobile phone 10 has an arrangement in which both the first feeding section 14 and the second feeding section 16 are connected to the single wireless circuit 18. In this case, the wireless circuit 18 can be either (i) a receiving wireless circuit such as a wireless circuit for diversity communication or (ii) a sending wireless circuit such as a wireless circuit for MIMO. Further, the wireless circuit 18 can be a combination of the receiving wireless circuit and the sending wireless circuit.

In the above explanation as to the arrangement illustrated in FIG. 9, the wireless circuit 18 is provided in the first body 11. Note, however, that the present invention is not limited to this, and the wireless circuit 18 can be provided either in the first body 11 or in the second body 12.

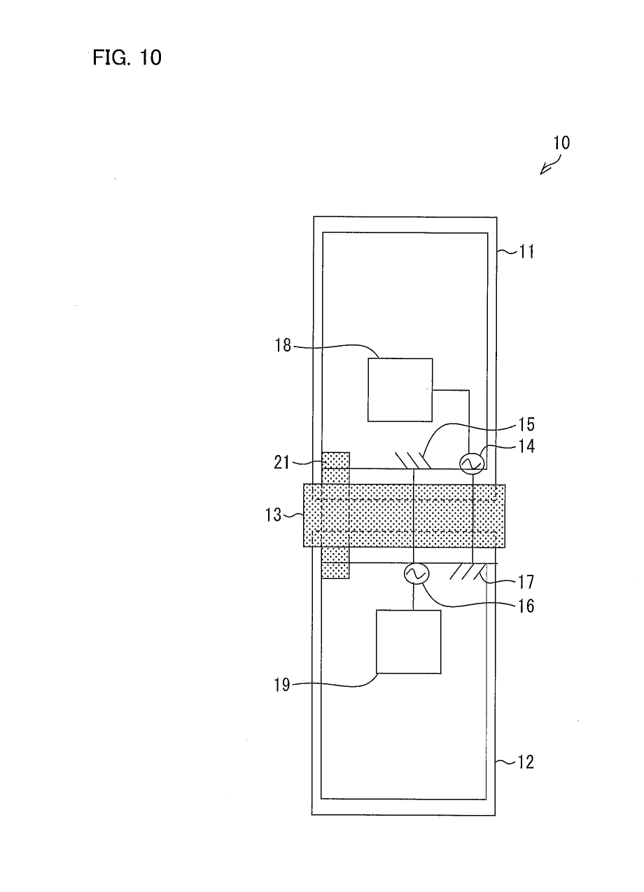

Further, the present invention is not limited to the arrangement in which the wireless circuit connected to the first feeding section 14 and the second feeding section 16 is used in a single system. It is possible to use wireless circuits in different systems, respectively. FIG. 10 is a view schematically illustrating an example of an arrangement in which the first feeding section 14 and the second feeding section 16 are connected to, respectively, wireless circuits which operates in different systems.

According to the arrangement illustrated in FIG. 10, a first wireless circuit 18 (which operates in a first frequency band) for a DTV is provided in the first body 11, and a second wireless circuit 19 (which operates in a second frequency band) for a wireless LAN is provided in the second body 12. The first wireless circuit 18 and the second wireless circuit can be wireless circuits having a conventional arrangement, and can be formed on, respectively, circuit substrates which provided in the first body 11 and the second body 12, respectively, for example. In a case where the first feeding section 14 and the second feeding section 16 are connected to, respectively, the wireless circuits which operates in different systems, the wireless circuits are not necessarily provided in the first body 11 and the second body 12, respectively. That is, the first wireless circuit 18 and the second wireless circuit 19 can be provided either in the first body 11 and the second body 12, respectively, or in one of the first body 11 and the second body 12.

In a case where the first feeding section 14 and the second feeding section 16 are connected to, respectively, the wireless circuits which are used in different systems (used in different frequency bands), it is preferable to adjust positions of the feeding sections so that a direction in which a current flows through the first ground 15 and a direction in which a current flows through the second ground 17 are orthogonal to each other. By causing the currents flowing through both antennas (the first ground 15 and the second ground 17) to be substantially orthogonal to each other, it is possible to have a reduction in a coupling amount between the antennas. This makes it possible to (i) suppress deterioration due to an influence of one of the antennas on the other one of antennas, and therefore (ii) ensure good antenna characteristics.

Here, in the present embodiment, both the first antenna and the second antenna are used while resonating with λ/4. Accordingly, among (i) one of ends of one of the grounds in a longitudinal direction the one of the grounds and (ii) one of ends of the one of the grounds in a short side direction of the one of grounds, a current flows from one of the feeding points to such an end that a distance between the one of feeding points and the end is closer to λ/4 in electrical length. For this reason, as to the feeding point of the system in which an electrical length of the ground in the lateral direction of the mobile phone 10 is closer to λ/4 of a used frequency, in a case where a length of the mobile phone 10 in a lateral direction (the short side direction of the ground) is closer to λ/4 of the used frequency than a length of the mobile phone 10 in a vertical direction (the longitudinal direction of the ground) is, it is also possible to cause a current to flow in a lateral direction of the ground by arranging, outside with respect to the lateral direction, the feeding section of the system. By causing a current of the other one of grounds, connected to the other one of feeding points, to flow in the vertical direction of the mobile phone 10, it becomes possible to cause the currents flowing through the respective antennas to be orthogonal to each other. In this case, there is a reduction in coupling amount between the antennas. It becomes thus possible to suppress deterioration of antenna characteristics due to influence of one of the antennas on the other one of the antennas, and therefore ensure good antenna characteristics.

For example, in a case where a difference between a length of the first ground 15 in the short side direction and ¼ of a wavelength of the second frequency band is smaller than a difference between a length of the second ground 17 in the short side direction and ¼ of a wavelength of the first frequency band, it is possible to cause a current to flow through the first ground in the short side direction by feeding a radio frequency signal to an end of the first ground 15 in the short side direction. It is thus possible to cause the currents flowing through the respective antennas to be orthogonal to each other. In order to feed a radio frequency signal to the end of the first ground 15 in the short side direction, the second feeding section 16 is connected to the end of the first ground 15 in the short side direction.

On the other hand, in a case where a difference between the length of the first ground 15 in the short side direction and ¼ of a wavelength of the second frequency band is not less than a difference between the length of the second ground 17 in the short side direction and ¼ of a wavelength of the first frequency band, it is possible to cause a current to flow through the second ground 17 in the short side direction by feeding a radio frequency signal to the end of the second ground 17 in the sort side direction. It is thus possible to cause the currents flowing through the respective antennas to be orthogonal to each other. In order to feed a radio frequency signal to the end of the second ground 17 in the short side direction, the first feeding section 14 is connected to the end of the second ground 17 in the short side direction.

Further, it is possible that a connection state of the first transmission line and a connection state of the second transmission line are switched in accordance with a positional relationship between the first body 11 and the second body 12. For example, it is possible to have such an arrangement that (i) in a case where the first body 11 and the second body 12 are in the open state, the first transmission line and the second transmission line are connected to each other directly or connected to each other capacitively, and (ii) in a case where the first body 11 and the second body 12 are in the closed state, the first transmission line and the second transmission line are not connected to each other (disconnected from each other). By causing the first transmission line and the second transmission line 12 not to be connected to each other state in the case where the first body 11 and the second body 12 are in the closed sate, it is possible to change a ground current flowing through the first body 11 or the second body 12. With the arrangement, it is possible to eliminate or reduce an influence of one of the antennas on the other one of the antennas. Note that it is possible that (i) both the transmission lines are in the disconnected state in accordance with the open/closed state of the bodies, or (ii) one of the transmission lines is in the disconnected state in accordance with the open/closed state the bodies.

For example, in a case where (i) the first ground 15 and the second feeding section 16 are connected to each other via the first feeding pad 22 and the second feeding pad 23 (see FIG. 2), and (ii) the first body 11 and the second body 12 are in the closed state, a distance between the first feeding pad 22 and the second feeding pad 23 becomes long so that the first feeding pad 22 and the second feeding pad 23 are not coupled with each other capacitively and a radio frequency signal is not fed between the first feeding pad 22 and the second feeding pad 23.

In this case, the first ground 15 does not serve as an antenna under a condition that the bodies are in the closed state. With the arrangement, by changing a conductive state of the grounds of the bodies by opening/closing the bodies, it is possible to reduce an influence of one of the antennas on the other one of the antennas or on the wireless circuit, under the condition that the bodies are in the closed state.

### Embodiment 2

Another embodiment of the present invention is described below with reference to drawings. Note that arrangements (including modified examples) other than an arrangement of the present embodiment are the same as arrangements of Embodiment 1 described above. Further, for the sake of simple explanation, members having the same functions as those of members illustrated in drawings of Embodiment 1 have the same signs as those of the members of Embodiment 1, and explanations of such members are omitted here.

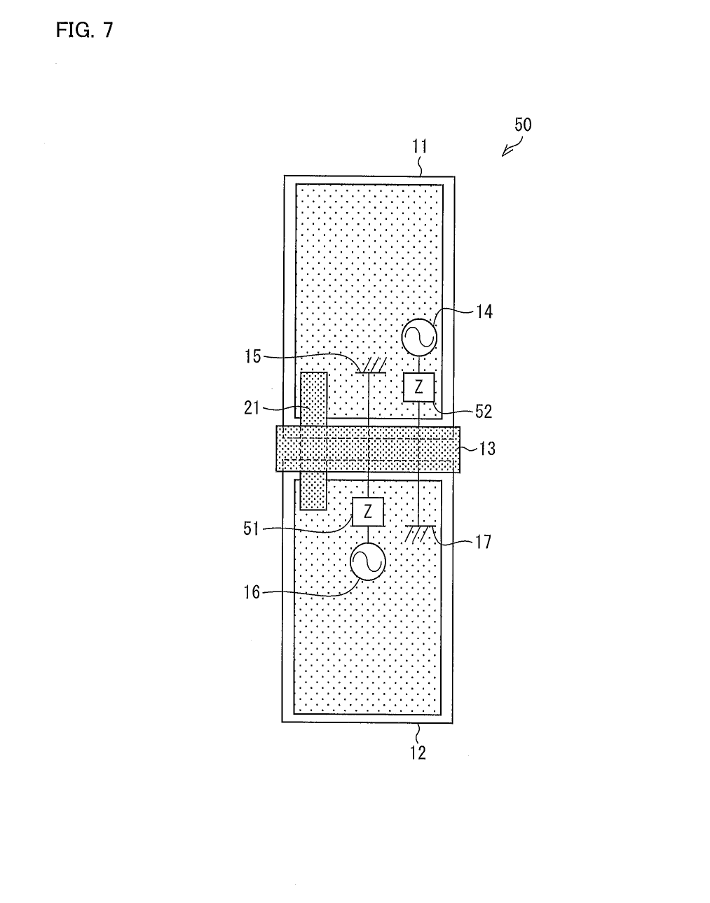

FIG. 7 is a view schematically illustrating an example of an arrangement of a mobile phone 50 of the present embodiment.

In addition to an arrangement of a mobile phone 10 of Embodiment 1 described above, the mobile phone 50 (portable wireless device) of the present embodiment includes a body connection section 21, a first impedance adjusting section 51, and a second impedance adjusting section 52 (see FIG. 7).

The first impedance adjusting section 51 matches, to each other, an impedance of the second feeding section 16 and an impedance of the first ground 15, and has a predetermined impedance (first impedance). The first impedance adjusting section 51 is provided (i) on a path via which the first ground 15 is electrically connected to the second feeding section 16 and (ii) in the second body 12.

The second impedance adjusting section 52 matches, to each other, an impedance of the first feeding section 14 and an impedance of the second ground 17, and has a predetermined impedance (second impedance). The second impedance adjusting section 52 is provided (i) on a path via which the second ground 17 is electrically connected to the first feeding section 14 and (ii) in the first body 11.

The first impedance adjusting section 51 and the second impedance adjusting section 52 can be realized by an arrangement in which a connection between a transmission line and a ground and a connection between the transmission line and a feeding point are made by capacitive high-frequency coupling (capacitive coupling), for example. Further, the first impedance adjusting section 51 and the second impedance adjusting section 52 can be also realized in such a manner that an inductance constant and a capacitance constant are arranged on a feeding line appropriately (arrangement of constants). The first impedance adjusting section 51 and the second impedance adjusting section 52 can be realized either by the capacity coupling or by the constant arrangement. Moreover, it is possible to realize the first impedance adjusting section 51 and the second impedance adjusting section 52 in different methods, respectively. For example, it is possible that the first impedance adjusting section 51 is realized by the capacity coupling and the second impedance adjusting section 52 is realized by the constant arrangement.

Further, the first impedance and the second impedance are not limited to impedances having fixed values (e.g., an inductor having a fixed value or a condenser having a fixed value), but may be variable impedances (e.g., a varicap or a variable inductor). In a case where the first impedance and the second impedance are variable impedances, it becomes possible to carry out, in accordance with a used system or a used channel, switching of a receiving frequency by adjusting an impedance value. Moreover, a value (constant) of the first impedance and a value (constant) of the second impedance can be either identical with each other or different from each other.

According to the mobile phone 50, by appropriately setting an impedance of the first impedance adjusting section 51, it becomes possible to cause an impedance of the second feeding section 16 and an impedance of the first ground 15 to match each other. Further, by appropriately setting an impedance of the second impedance adjusting section 52, it becomes possible to cause an impedance of the first feeding section 14 and an impedance of the second ground 17 to match each other.

According to the mobile phone 50, the first impedance adjusting section 51 is provided in the second body 12, and the second impedance adjusting section 52 is provided in the first body 11. Note, however, that the present invention is not limited to this. The first impedance adjusting section 51 can be provided in any one of the first body 11, the second body 12, and the body coupling section 13, as long as the first impedance adjusting section 51 is provided on a path via which the first ground 15 is electrically connected to the second feeding section 16. The second impedance adjusting section 52 can be provided in any one of the first body 11, the second body 12, and the body coupling section 13, as long as the second impedance adjusting section 52 is provided on a path via which the second ground 17 is electrically connected to the first feeding section 14.

### Embodiment 3

Another embodiment of the present invention is described below with reference to drawings. Note that arrangements other than an arrangement described in the present embodiment are the same as those of Embodiments 1 and 2 described above. Further, for the sake of simple explanation, members having the same functions as those of members illustrated in drawings of Embodiments 1 and 2 have the same signs as those of the members of Embodiments 1 and 2, and explanations of such members are omitted here.

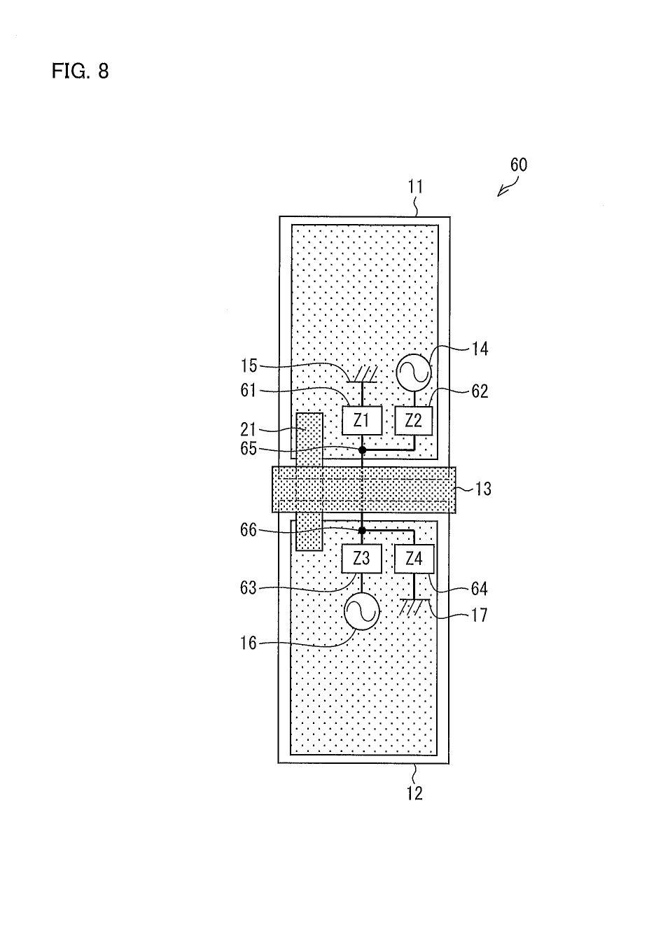

FIG. 8 is a view schematically illustrating an example of an arrangement of a mobile phone 60 of the present embodiment.

In addition to an arrangement of a mobile phone 10 of Embodiment 1 described above, the mobile phone 60 (portable wireless device) of the present embodiment includes a body connection section 21, a first impedance adjusting section 61, a second impedance adjusting section 62, a third impedance adjusting section 63, and a fourth impedance adjusting section 64 (see FIG. 8).

A body coupling section 13 of the mobile phone 60 includes a single transmission line for feeding a radio frequency signal. That is, the single transmission line is shared. The transmission line has two terminals. One (first terminal) of the two terminals of the transmission line is electrically connected to, via a first branch point 65, both a first feeding section 14 and a first ground 15. The other one (second terminal) of the two terminals is electrically connected to, via a second branch point 66, both a second feeding section 16 and a second ground 17.

The first impedance adjusting section 61 causes an impedance of the second feeding section 16 and an impedance of the first ground 15 to match each other, and has a predetermined impedance (first impedance). The first impedance adjusting section 61 is provided (i) on a path via which the first ground 15 is electrically connected to the first branch point 65 and (ii) in a first body 11.

The second impedance adjusting section 62 causes an impedance of the first feeding section 14 and an impedance of the second ground 17 to match each other, and has a predetermined impedance (second impedance). The second impedance adjusting section 62 is provided (i) on a path via which the first feeding section 14 is electrically connected to the first branch point 65 and (ii) in the first body 11.

The third impedance adjusting section 63 causes an impedance of the second feeding section 16 and an impedance of the first ground 15 to match each other, and has a predetermined impedance (third impedance). The third impedance adjusting section 63 is provided (i) on a path via which the second feeding section 16 is electrically connected to the second branch point 66 and (ii) in the second body 12.

The fourth impedance adjusting section 64 causes an impedance of the first feeding section 14 and an impedance of the second ground 17 to match each other, and has a predetermined impedance (fourth impedance). The fourth impedance adjusting section 64 is provided (i) on a path via which the second ground 17 is electrically connected to the second branch point 66 and (ii) in a second body 12.

The first impedance adjusting section 61, the second impedance adjusting section 62, the third impedance adjusting section 63, and the fourth impedance adjusting section 64 can be realized by capacity coupling or a constant arrangement, for example. Values (constants) of the first impedance, the second impedance, the third impedance, and the fourth impedance can be either identical with each other, or different from each other. Further, the first impedance, the second impedance, the third impedance, and the fourth impedance can be impedances having fixed values, or variable impedances.

Moreover, the first impedance and the third impedance have such a frequency characteristic that the first impedance adjusting section 61 and the third impedance adjusting section 63 transmit only a current signal of a frequency band used by a first antenna. The second impedance and the fourth impedance have such a frequency characteristic that the second impedance adjusting section 62 and the fourth impedance adjusting section 64 transmit only a current signal of a frequency band used by a second antenna. With the arrangement, the first impedance adjusting section 61 and the third impedance adjusting section 63 serve as filters which transmit the frequency band used by the first antenna. Meanwhile, the second impedance adjusting section 62 and the fourth impedance adjusting section 64 serve as filters which transmit the frequency band used by the second antenna.

Since the mobile phone 60 has the arrangement in which the first impedance adjusting section 61 and the third impedance adjusting section 63 serve as the filters which transmit the frequency band used by the first antenna, and the second impedance adjusting section 62 and the fourth impedance adjusting section 64 serve as the filters which transmit the frequency band used by the second antenna, it becomes possible to, for example, prevent (i) the first feeding section 14 from feeding a radio frequency signal to the first ground 15 and (ii) the second feeding section 16 from feeding a radio frequency signal to the second ground 17.

Accordingly, it is possible for the second feeding section 16 to feed a radio frequency signal to the first ground via the third impedance adjusting section 63, the transmission line, and the first impedance adjusting section 61. This makes it possible to (i) excite the first ground 15, and therefore (ii) cause the first ground 15 (i.e., the first body 11) to serve as the first antenna. Further, it is possible for the first feeding section 14 to feed a radio frequency signal to the second ground 17 via the second impedance adjusting section 62, the transmission line, and the fourth impedance adjusting section 64. This makes it possible to (i) excite the second ground 17, and therefore (ii) cause the second ground 17 (i.e., the second body 12) to serve as the second antenna.

For the reasons described above, it is possible to cause the first antenna and the second antenna to operate suitably in the respective frequency bands which are different from each other, even in a case where a single transmission line is shared. Further, since only a single transmission line is used, it is possible for the body coupling section 13 to have a simple arrangement for the transmission line.

Furthermore, in a case where (i) the first antenna and the second antenna are in operation simultaneously and (ii) the first body 11 is held in a hand, deterioration of antenna characteristics of the second antenna is less than deterioration of antenna characteristics of the first antenna. Meanwhile, in a case where (i) the first antenna and the second antenna are in operation simultaneously and (ii) the second body 12 is held in a hand, the deterioration of antenna characteristics of the first antenna is less than the deterioration of antenna characteristics of the second antenna. Accordingly, even in a case where any one of the first body 11 and the second body 12 is held in a hand, it is possible to reduce deterioration of antenna characteristics of the entire mobile phone 60, particularly, by use of a diversity technique, for example.

For the reasons described above, the mobile phone 60 having the first antenna and the second antenna, each employing excitation of a corresponding body, can have a reduction in deterioration of antenna characteristics, even in a case where the first body 11 or the second body 12 is held in a hand.

Note that the first impedance adjusting section 61, the second impedance adjusting section 62, the third impedance adjusting section 63, and the fourth impedance adjusting section 64 are not limited to the aforementioned filters each of which transmits a predetermined frequency band, and can be filters each of which cuts a predetermined frequency band. For example, it is possible to have an arrangement in which (i) the first impedance adjusting section 61 and the third impedance adjusting section 63 are filters which cut the frequency band used by the second antenna, and (ii) the second impedance adjusting section 62 and the fourth impedance adjusting section 64 are filters which cut the frequency band used by the first antenna.

Further, the mobile phone 60 has an arrangement in which the first impedance adjusting section 61 and the second impedance adjusting section 62 are provided in the first body 11, and the third impedance adjusting section 63 and the fourth impedance adjusting section 64 are provided in the second body 12. Note, however, that the present invention is not limited to this. That is, the first branch point 65 can be provided either in the first body 11 or in the body coupling section 13. The second branch point 66 can be provided either in the second body 12 or in the body coupling section 13. Accordingly, the first impedance adjusting section 61 can be provided in any one of the first body 11 and the body coupling section 13, as long as the first impedance adjusting section 61 is provided on a path via which the first ground 15 is electrically connected to the first branch point 65. The second impedance adjusting section 62 can be provided in any one of the first body 11 and the body coupling section 13, as long as the second impedance adjusting section 62 is provided on a path via which the first feeding section 14 is electrically connected to the first branch point 65. The third impedance adjusting section 63 can be provided in any one of the second body 12 and the body coupling section 13, as long as the third impedance adjusting section 63 is provided on a path via which the second feeding section 16 is electrically connected to the second branch point 66. The fourth impedance adjusting section 64 can be provided in any one of the second body 12 and the body coupling section 13, as long as the fourth impedance adjusting section 64 is provided on a path via which the second ground 17 is electrically connected to the second branch point 66.

Further, the first branch point 65 and the second branch point 66 can have an arrangement in which an electric wire is merely branched, or an arrangement in which a switch (not illustrated) is used. For example, as the first branch point 65, a switch (first switch) for switching a connection of a first terminal of the transmission line between the first feeding section 14 and the ground 15 is used. As the second branch point 66, a switch (second switch) for switching a connection of a second terminal of the transmission line between the second feeding section 16 and the second ground 17 is used.

In a case where the first switch and the second switch are provided, it becomes possible to prevent successfully (i) the first feeding section 14 from feeding a radio frequency signal to the first ground 15 and (ii) the second feeding section 16 from feeding a radio frequency signal to the second ground 17. Accordingly, by (i) causing impedances of the impedance adjusting sections 61 through 64 to be identical with each other in frequency characteristic and (ii) carrying out switching of the first switch and switching of the second switch, it becomes possible to cause the first antenna and the second antenna to operate with the same frequency.

Further, in a case where the first switch and the second switch are provided, all the impedance adjusting sections 61 through 64 are not necessarily provided. That is, in a case where, among the aforementioned arrangements of the mobile phone 60, the arrangement in which the first impedance adjusting section 61, the second impedance adjusting section 62, the third impedance adjusting section 63, and the fourth impedance adjusting section 64 are not provided is employed, it is possible to have an arrangement employing a first switch and a second switch. According to this arrangement, by carrying out switching of the first switch and switching of the second switch, it is possible to cause the first antenna and the second antenna to operate either with the same frequency or with different frequencies, respectively.

### Embodiment 4

Another embodiment of the present invention is described below with reference to drawings. Note that arrangements (including modified examples) other than an arrangement described in the present embodiment are the same as those of Embodiments 1 through 3. Further, for the sake of simple explanation, members having the same functions as those of members illustrated in drawings of Embodiments 1 through 3 have the same signs as those of the members of embodiments 1 through 3, and explanations of such members are omitted here.

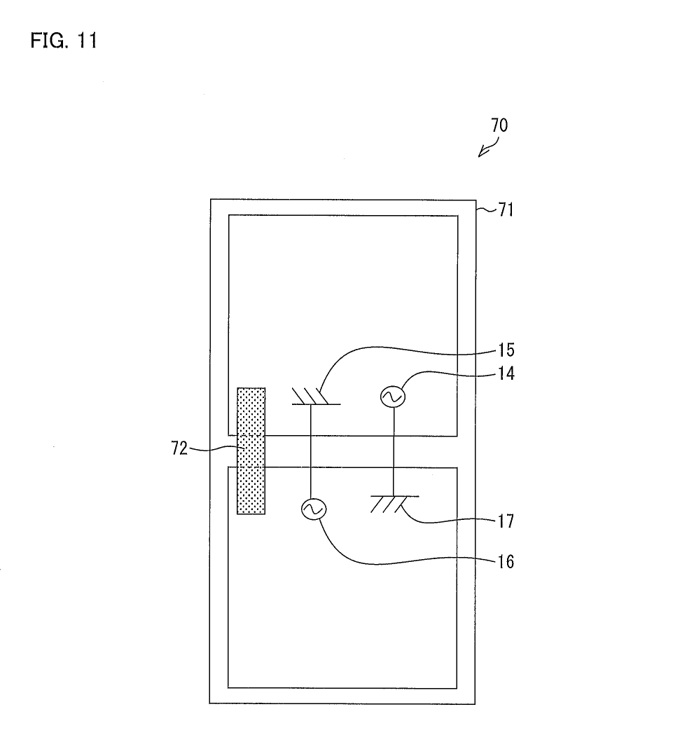

FIG. 11 is a view schematically illustrating an example of an arrangement of a mobile phone 70 of the present embodiment.

As illustrated in FIG. 11, the mobile phone 70 (portable wireless device) of the present embodiment has such an arrangement that (i) an arrangement of a mobile phone 10 of Embodiment 1 described above is realized by a single body 71 in place of a first body 11 and a second body 12, and (ii) a body coupling section 13 is not provided.

In the body 71, a first wireless circuit to which a first ground 15 provides a reference potential and a second wireless circuit to which a second ground 17 provides a reference potential are provided. The first ground 15 and the second ground 17 are provided so as to be away from each other by a predetermined distance (at least such a distance that the first ground 15 and the second ground 17 are not capacitively coupled with each other). The first wireless circuit is connected to a first feeding section 14, and the second wireless circuit is connected to a second feeding section 16. Further, the first wireless circuit and the second wireless circuit are connected to each other via a circuit connection section 72 constituted by a coaxial cable and the like. The first feeding section 16 feeds, via a first transmission line, a radio frequency signal to the second ground 17, and the second feeding section 16 feeds, via a second transmission line, a radio frequency signal to the first ground 15. With the arrangement, it is possible to cause each of the grounds to serve as an antenna.

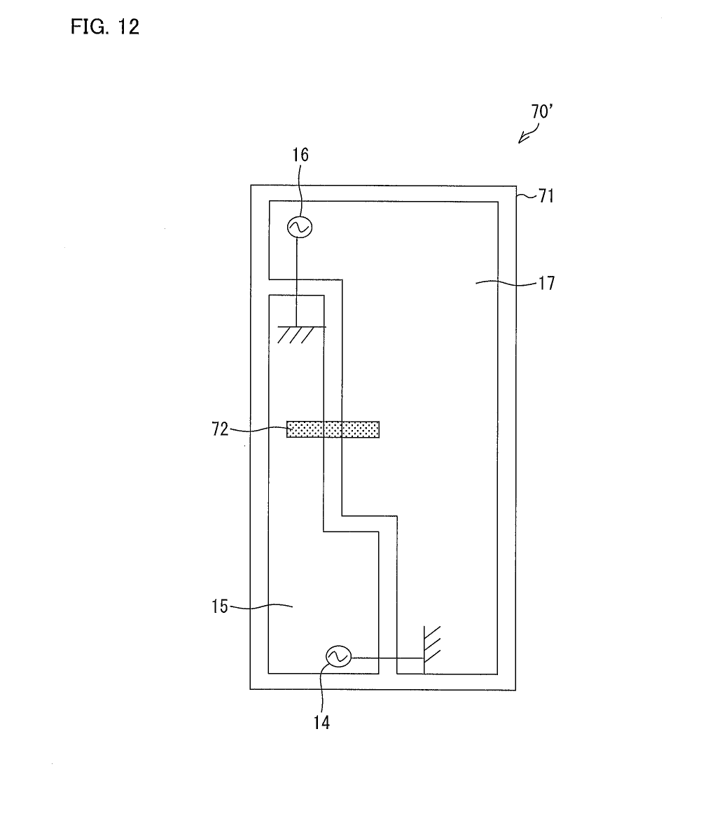

In FIG. 11, the first ground 15 and the second ground 17 are substantially identical with each other in shape. Note, however, that the present embodiment is not limited to this, and a shape of the first ground 15 and a shape of the second ground 17 can be different from each other. For example, the first ground 15 and the second ground 17 can have shapes of in a mobile phone 70′ illustrated in FIG. 12.

As described above, a portable wireless device of the present invention does not necessarily has two bodies, as long as the portable wireless device includes: a first feeding section; a first ground for providing a reference potential to the first feeding section; a second feeding section; a second ground for providing a reference potential to the second feeding section; a first transmission line via which the first feeding section and the second ground are electrically connected to each other; and a second transmission line via which the second feeding section and the first ground are electrically connected to each other.

### Embodiment 5

Another embodiment of the present invention is described below with reference to drawings. Note that arrangements (including modified examples) other than an arrangement described in the present embodiment are the same as those of Embodiments 1 through 4. Further, for the sake of simple explanation, members having the same functions as those of members illustrated in drawings of Embodiments 1 through 4 described above have the same signs as those of the members of Embodiments 1 through 4, and explanations of such members are omitted here.

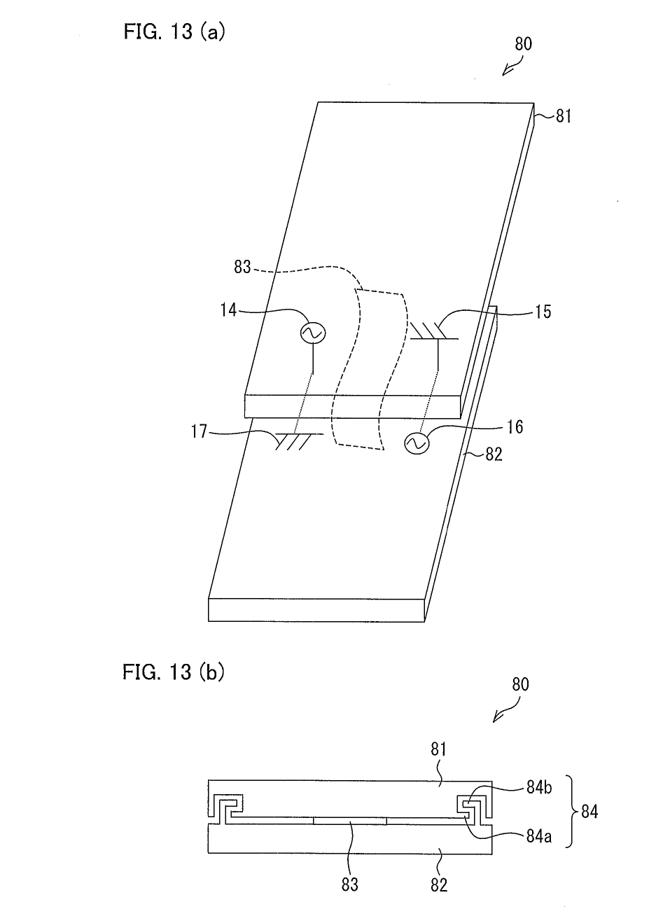

FIG. 13 is a view schematically illustrating an example of an arrangement of a mobile phone 80 of the present embodiment. FIG. 13(a) is a perspective view illustrating an outline of the arrangement of the mobile phone 80. FIG. 13(b) is a cross-sectional view illustrating the mobile phone 80.

As illustrated in FIG. 13, the mobile phone 80 (portable wireless device) of the present embodiment has such an arrangement that (i), in an arrangement of a mobile phone 10 of Embodiment 1 described above, a first body 81 and a second body 82 are provided in place of a first body 11 and a second body 12. The first body 11 and the second body 12 are coupled with each other so as to be rotatable forward and backward by use of a body coupling section 13. Meanwhile, the first body 81 and the second body 82 are coupled with each other so as to be slidable with respect to each other by use of a body coupling section (not illustrated), such as a guide rail, provided between the first body 81 and the second body 82.

On a surface of the first body 81, which surface faces the second body 82, a guide rail 84a (body coupling section 84) is provided along a longitudinal direction of the first body 81, for example. A claw hook 84b (body coupling section 84) of the second body 82 is attached to the guide rail 84a so that the first body 81 is slidable with respect to the second body 82. An arrangement of the body coupling section is not limited to this. It is possible to employ, as the body coupling section, a slidable mechanism of a general slidable-type portable wireless device. Further, a wireless circuit provided in the first body 81 and another wireless circuit provided in the second body 82 are connected to each other via the body connection section 83. The body connection section 83 is configured such that, even if the first body 81 is slid with respect to the second body 82, a connection between the first body 81 and the second body 82 is ensured. For example, the body connection section 83 can be constituted by a coaxial cable, a flexible printed circuit, or the like.

The mobile phone 80 of the present embodiment is different from the mobile phone 10 of Embodiment 1 described above only in a coupling arrangement between the first body 81 and the second body 82. According to the mobile phone 80, it is possible, in the same manner as the mobile phone 10, that (i) a first feeding section 16 feeds a radio frequency signal to a second ground 17 via a first transmission line, and a second feeding section 16 feeds a radio frequency signal to a first ground 15 via a second transmission line, and therefore (ii) each of the grounds can serve as an antenna.

Note that, in the present embodiment, it is possible to switch a connection state of at least one of the first transmission line and the second transmission line in accordance with an open/closed state of the bodies, in the same manner as a modified example of Embodiment 1. For example, (i) in a case where the bodies are in the open state (in a state where the first body 81 and the second body 82 overlap each other slightly), the first transmission line and the second transmission line are electrically connected to each other either directly or capacitively, and (ii) in a case where the bodies are in the closed state (in a state where the entire first body 81 and the entire second body 82 overlap each other), the first transmission line and the second transmission line are electrically disconnected from each other. With the arrangement, it is possible to reduce an influence of one of the antennas on the other one of the antennas, and an influence of the one of antennas on a wireless circuit, in a case where the bodies are in the closed state.

### CONCLUSION

As described above, a portable wireless device of the present invention includes: a first feeding section; a first ground for providing a reference potential to the first feeding section; a second feeding section; a second ground for providing a reference potential to the second feeding section; a first transmission line via which the first feeding section and the second ground are electrically connected to each other; and a second transmission line via which the second feeding section and the first ground are electrically connected to each other.

According to the arrangement, the second feeding section feeds a radio frequency signal to the first ground, so as to excite the first ground. This makes it possible to cause the first ground to serve as an antenna element (first antenna). Further, the first feeding section feeds a radio frequency signal to the second ground, so as to excite the second ground. This makes it possible to cause the second ground to serve as an antenna element (second antenna). Furthermore, in a case where (i) the first antenna and the second antenna are in operation simultaneously and (ii) a part in the vicinity of the first ground is held in a hand, deterioration of antenna characteristics of the second antenna is less than deterioration of antenna characteristics of the first antenna. Meanwhile, in a case where (i) the first antenna and the second antenna are in operation simultaneously and (ii) a part in the vicinity of the second ground is held in a hand, the deterioration of antenna characteristics of the first antenna is less than the deterioration of antenna characteristics of the second antenna. For these reasons, even in a case where any one of the part in the vicinity of the first ground and the part in the vicinity of the second ground is held in a hand, it is possible to reduce deterioration of antenna characteristics of the entire portable wireless device, particularly, by use of a diversity technique, for example.

Accordingly, with the portable wireless device having an arrangement in which (i) a radio frequency signal is fed to the grounds and therefore (ii) the first antenna and the second antenna are realized, it is possible to reduce deterioration of antenna characteristics, even in a case where one of the parts in the vicinity of the grounds is held in a hand.

The portable wireless device of the present invention preferably further includes: a first body; a second body; and a body coupling section for causing the first body and the second body to be coupled with each other, the first feeding section and the first ground being provided in the first body, the second feeding section and the second ground being provided in the second body, the first transmission line and the second transmission line being provided in the body coupling section.

According to the arrangement, even in a case where (i) the first antenna and the second antenna employ excitation of respective bodies and (ii) the first body or the second body is held in a hand, it is possible to reduce deterioration of antenna characteristics. That is, the second feeding section feeds a radio frequency signal to the first ground, so as to excite the first ground (e.g., a ground pattern of a substrate provided in the first body, or a frame of the first body). This makes it possible to cause the first ground (i.e., the first body) to serve as an antenna element (first antenna). Further, the first feeding section feeds a radio frequency signal to the second ground, so as to excite the second ground (e.g., a ground pattern of a substrate provided in the second body, or a frame of the second body). This makes it possible to cause the second ground (i.e., the second body) to serve as an antenna element (second antenna).

Further, in a case where (i) the first antenna and the second antenna are in operation simultaneously and (ii) the first body is held in a hand, deterioration of antenna characteristics of the second antenna is less than deterioration of antenna characteristics of the first antenna. Meanwhile, in a case where (i) the first antenna and the second antenna are in operation simultaneously and (ii) the second body is held in a hand, the deterioration of antenna characteristics of the first antenna is less than the deterioration of antenna characteristics of the second antenna. For these reasons, even in a case where any one of the first body and the second body is held in a hand, it is possible to reduce deterioration of antenna characteristics of the entire portable wireless device, particularly, by use of a diversity technique, for example.

The portable wireless device of the present invention can be arranged such that the first body and the second body are coupled with each other so as to be rotatable forward and backward by using the body coupling section as an axis of rotation. The portable wireless device of the present invention can be arranged such that the first body and the second body are coupled with each other so as to be slidable with respect to each other by use of the body coupling section provided between the first body and the second body. According to such arrangements, it is possible to cause the portable wireless device of the present invention to have a foldable-type structure or a slidable-type structure, suitably.

Furthermore, the portable wireless device of the present invention preferably further includes: a first impedance adjusting section having a first impedance, the first impedance adjusting section being provided on a path via which the first ground is electrically connected to the second feeding section; and a second impedance adjusting section having a second impedance, the second impedance adjusting section being provided on a path via which the second ground is electrically connected to the first feeding section.

According to the arrangement, by appropriately setting the first impedance of the first impedance adjusting section, it becomes possible to cause an impedance of the second feeding section and an impedance of the first ground to match each other. Further, by appropriately setting the second impedance of the second impedance adjusting section, it becomes possible to cause an impedance of the first feeding section and an impedance of the second ground to match each other.

Moreover, the portable wireless device of the present invention is preferably arranged such that at least one of the first impedance and the second impedance is a variable impedance. According to the arrangement, by adjusting an impedance value, it becomes possible to carry out switching of a reception frequency in accordance with a used system or a used channel.

Further, the portable wireless device of the present invention is preferably arranged such that at least one of the first transmission line and the second transmission line has an arrangement in which an input and an output are high-frequency coupled with each other capacitively. According to the arrangement, it is possible to form a feeding line, even in a case where the portable wireless device has an arrangement in which a direct connection (DC) cannot be ensured.

Alternatively the portable wireless device of the present invention can be arranged such that at least one of the first transmission line and the second transmission line has an arrangement in which an input and an output are connected to each other directly.

Furthermore, the portable wireless device of the present invention can be arranged such that one of the first transmission line and the second transmission line has an arrangement in which an input and an output are high-frequency coupled with each other capacitively; and the other one of the first transmission line and the second transmission line has an arrangement in which an input and an output are coupled with each other directly.

Moreover, a portable wireless device of the present invention can include: a first feeding section; a first ground for providing a reference potential to the first feeding section; a second feeding section; a second ground for providing a reference potential to the second feeding section; and a transmission line having a first terminal and a second terminal, the first terminal of the transmission line being electrically connected to, via a first branch point provided between the first terminal and the second terminal, both the first feeding section and the first ground, the second terminal of the transmission line being electrically connected to, via a second branch point provided between the first branch point and the second terminal, both the second feeding section and the second ground.

According to the arrangement, by separating a signal by use of an impedance having a frequency characteristic or carrying out switching of a signal by use of a switch, for example, it becomes possible to prevent (i) the first feeding section from feeding a radio frequency signal to the first ground and (ii) the second feeding section from feeding a radio frequency signal to the second ground.

Accordingly, it becomes possible for the second feeding section to feed a radio frequency signal to the first ground via the transmission line, so as to excite the first ground. This makes it possible to cause the first ground to serve as an antenna element (first antenna). Further, it becomes possible for the first feeding section to feed a radio frequency signal to the second ground via the transmission line, so as to excite the second ground. This makes it possible to cause the second ground to serve as an antenna element (second antenna).

For these reasons, even in a case where a single transmission line is shared, it is possible to cause the first antenna and the second antenna to operate suitably, either in a single frequency band or in different frequency bands, respectively. Further, since only a single transmission line is required, it is possible to have a simple arrangement of the transmission line.

Moreover, in a case where (i) the first antenna and the second antenna are in operation simultaneously and (ii) a part in the vicinity of the first ground is held in a hand, deterioration of antenna characteristics of the second ground is less than deterioration of antenna characteristics of the first antenna. Meanwhile, in a case where (i) the first antenna and the second antenna are in operation simultaneously and (ii) a part in the vicinity of the second ground is held in a hand, the deterioration of antenna characteristics of the first antenna is less than the deterioration of antenna characteristics of the second antenna. For these reasons, even in a case any one of the part in the vicinity of the first ground and the part in the vicinity of the second ground is held in a hand, it is possible to reduce deterioration of antenna characteristics of the entire portable wireless device, particularly, by use of a diversity technique, for example.

According to the arrangement, even in a case where (i) the portable wireless device has an arrangement in which a radio frequency signal is fed to the grounds and therefore the first antenna and the second antenna are realized and (ii) the parts(s) of the ground(s) is held in a hand, it is possible to reduce deterioration of antenna characteristics.

The portable wireless device of the present invention preferably further includes: a first body; a second body; and a body coupling section via which the first body and the second body are coupled with each other, the first feeding section and the first ground being provided in the first body, the second feeding section and the second ground being provided in the second body, the transmission line being provided in the body coupling section, the first branch point being provided in one of the first body and the body coupling section, the second branch point being provided in one of the second body and the body coupling section.

According to the arrangement, even in a case where (i) the portable wireless device has an arrangement in which the first antenna and the second antenna employ excitation of respective bodies and (ii) the first body or the second body is held in a hand, it is possible to reduce deterioration of antenna characteristics. That is, According to the arrangement, by separating a signal by use of an impedance having a frequency characteristic or carrying out switching of a signal by use of a switch, for example, it becomes possible to prevent (i) the first feeding section from feeding a radio frequency signal to the first ground and (ii) the second feeding section from feeding a radio frequency signal to the second ground.

Accordingly, it becomes possible for the second feeding section to feed a radio frequency signal to the first ground via the transmission line, so as to excite the first ground (e.g., a ground pattern of a substrate provided in the first body, or a frame of the first body). This makes it possible to cause the first ground (i.e., the first body) to serve as an antenna element (first antenna). Further, it becomes possible for the first feeding section to feed a radio frequency signal to the second ground via the transmission line, so as to excite the second ground (e.g., a ground pattern of a substrate provided in the second body, or a frame of the second body). This makes it possible to cause the second ground (i.e., the second body) to serve as an antenna element (second antenna).

Accordingly, even in a case where a single transmission line is shared, it is possible to cause the first antenna and the second antenna to operate suitably either in a single frequency band or in different frequency bands, respectively. Further, since only a single transmission line is required, it is possible for the body coupling section to have a simple arrangement for the transmission line.

Moreover, in a case where (i) the first antenna and the second antenna are in operation simultaneously and (ii) the first body is held in a hand, deterioration of antenna characteristics of the second antenna is less than deterioration of antenna characteristics of the first antenna. Meanwhile, in a case where (i) the first antenna and the second antenna are in operation simultaneously and (ii) the second body is held in a hand, the deterioration of antenna characteristics of the first antenna is less than the deterioration of antenna characteristics of the second antenna. For these reasons, even in a case where any one of the first body and the second body is held in a hand, it is possible to reduce deterioration of the entire portable wireless device, particularly, by use of a diversity technique, for example.

The portable wireless device of the present invention can be arranged such that the first body and the second body are coupled with each other so as to be rotatable forward and backward by using the body coupling section as an axis of rotation. Further, the portable wireless device of the present invention can be also arranged such that the first body and the second body are coupled with each other so as to be slidable with respect to each other by use of the body coupling section provided between the first body and the second body. According to the arrangements, it is possible to cause the portable wireless device of the present invention to have a foldable-type structure or a slidable-type structure, suitably.

Moreover, the portable wireless device of the present invention preferably further includes: a first impedance adjusting section having a first impedance, the first impedance adjusting section being provided on a path via which the first ground is electrically connected to the first branch point; a second impedance adjusting section having a second impedance, the second impedance adjusting section being provided on a path via which the first feeding section is electrically connected to the first branch point; a third impedance adjusting section having a third impedance, the third impedance adjusting section being provided on a path via which the second feeding section is electrically connected to the second branch point; and a fourth impedance adjusting section having a fourth impedance, the fourth impedance adjusting section being provided on a path via which the second ground is electrically connected to the second branch point.

According to the arrangement, by (i) causing the first impedance and the third impedance to have such a frequency characteristic that the first impedance adjusting section and the third impedance adjusting section transmit only a current signal in a frequency band used by the first antenna, and (ii) causing the second impedance and the fourth impedance to have such a frequency characteristic that the second impedance adjusting section and the fourth impedance adjusting section transmit only a current signal in a frequency band used by the second antenna, for example, it is possible to prevent (i) the first feeding section from feeding a radio frequency signal to the first ground and (ii) the second feeding section from feeding a radio frequency signal to the second ground.

Further, the portable wireless device of the present invention is preferably arranged such that the first branch point is a first switch for switching a connection of the first terminal of the transmission line between the first feeding section and the first ground, and the second branch point is a second switch for switching a connection of the second terminal of the transmission line between the second feeding section and the second ground.

According to the arrangement, by carrying out switching of the first switch and switching of the second switch, it becomes possible to prevent (i) the first feeding section from feeding a radio frequency signal to the first ground and (ii) the second feeding section from feeding a radio frequency signal to the second ground.

Furthermore, the portable wireless device of the present invention is preferably arranged such that at least one of the first impedance, the second impedance, the third impedance, and the fourth impedance is a variable impedance. According to the arrangement, by adjusting an impedance value, it becomes possible to carry out switching of a reception frequency in accordance with a used system or a used channel.

Moreover, the portable wireless device of the present invention is preferably arranged such that the transmission line has an arrangement in which the first terminal and the second terminal are high-frequency coupled with each other capacitively. According to the arrangement, it is possible to form a feeding line, even in a case where the portable wireless device has such a structure that a direct connection (DC) cannot be ensured.

Alternatively, the portable wireless device of the present invention can be arranged such that the transmission line has an arrangement in which the first terminal and the second terminal are connected to each other directly.

Furthermore, the portable wireless device of the present invention can be arranged such that a connection state of at least one of the first transmission line(s) is subjected to switching in accordance with a positional relationship between the first body and the second body.

According to the arrangement, a connection state of at least one of the first transmission line, the second transmission line, and the transmission line including the first terminal and the second terminal can be switched in accordance with a positional relationship between the first body and the second body. For example, in a case where the first body and the second body overlap each other, that is, in a case where the positional relationship between the first body and the second body is such that a compact size of the portable wireless device is given priority over operability of the portable wireless device (in a case where the bodies are in a closed state), it is possible to reduce an influence of one of the antennas on the other one of the antennas by (i) causing the at least one of the transmission line(s) to be in a disconnected state and therefore (ii) suppressing a current flowing through a corresponding ground (antenna). As such, since the current flowing through the ground (antenna) can be appropriately suppressed in accordance with a positional relationship between the bodies, it is possible to carry out wireless communication suitably.

Moreover, the portable wireless device of the present invention can be arranged such that the first feeding section is connected to a first wireless circuit used in a first frequency band, the second feeding section is connected to a second wireless circuit used in a second frequency band which is different from the first frequency band, in a case where a difference between a length of the first ground in a short side direction and ¼ of a wavelength of the second frequency band is less than a difference between a length of the second ground in the short side direction and ¼ of a wavelength of the first frequency band, the second feeding section is connected to one of ends of the first ground in the sort side direction, and in a case where the difference between the length of the first ground in the short side direction and ¼ of the wavelength of the second frequency band is not less than the difference between the length of the second ground in the short side direction and ¼ of the wavelength of first frequency band, the first feeding section is connected to one of ends of the second ground in the short side direction.

For example, both the first antenna and the second antenna are used while resonating with λ/4. In this case, among a longitudinal direction and a short side direction, a current flows in such a direction that an electrical length of from a feeding section to an end of a ground is closer to λ/4. For this reason, according to the arrangement, (i) a current is likely to flow in a longitudinal direction of a ground in one of antennas, and (ii) a current is likely to flow in a short side direction of a ground in the other one of antennas. It is thus possible to cause the currents flowing through grounds to be orthogonal to each other. With the arrangement, in a case there the first antenna and the second antenna are in operation, it is possible to cause the currents flowing through the grounds to be orthogonal to each other so as to reduce a coupling amount between the antennas. This makes it possible to suppress deterioration of antenna characteristics due to an influence of one of the antennas on the other one of the antennas, and therefore ensure good antenna characteristics.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is suitably used in a field related to a portable wireless device having an antenna employing excitation of a body. The present invention is also suitably used in a field related to a method of manufacturing a portable wireless device, a field related to a communication method of a portable wireless device, a field related to a method of controlling an antenna, and the like.

### REFERENCE SIGNS LIST

10, 50, 60, 70, 70′, 80: Mobile phone (portable wireless device)
11, 81: First body
12, 82: Second body
13, 84: Body coupling section
14: First feeding section
15: First ground
16: Second feeding section
17: Second ground
21, 83: Body connection section
22: First feeding pad
23: Second feeding pad
24: Conductor
30A: Communication system
30B: Communication system
31: First antenna
32: Second antenna
34: Tuner
43: First tuner
44: Second tuner
51: First impedance adjusting section
52: Second impedance adjusting section
61: First impedance adjusting section
62: Second impedance adjusting section
63: Third impedance adjusting section
64: Fourth impedance adjusting section
65: First branch point
66: Second branch point
71: Body
72: Circuit connection section

1.-21. (canceled)

22. A portable wireless device comprising:
a first feeding section;
a first ground for providing a reference potential to the first feeding section;
a second feeding section;
a second ground for providing a reference potential to the second feeding section;
a first transmission line via which the first feeding section and the second ground are electrically connected to each other; and
a second transmission line via which the second feeding section and the first ground are electrically connected to each other.

23. The portable wireless device as set forth in claim 22, further comprising:
a first body;
a second body; and
a body coupling section for causing the first body and the second body to be coupled with each other,
the first feeding section and the first ground being provided in the first body,
the second feeding section and the second ground being provided in the second body,
the first transmission line and the second transmission line being provided in the body coupling section.

24. The portable wireless device as set forth in claim 23, wherein:
the first ground is caused to serve as a first antenna for a diversity technique; and
the second ground is caused to serve as a second antenna for the diversity technique.

25. The portable wireless device as set forth in claim 24, wherein:
the first body and the second body are coupled with each other so as to be rotatable forward and backward by using the body coupling section as an axis of rotation.

26. The portable wireless device as set forth in claim 24, wherein:
the first body and the second body are coupled with each other so as to be slidable with respect to each other by use of the body coupling section provided between the first body and the second body.

27. The portable wireless device as set forth in claim 24, further comprising:
a first impedance adjusting section having a first impedance, the first impedance adjusting section being provided on a path via which the first ground is electrically connected to the second feeding section; and
a second impedance adjusting section having a second impedance, the second impedance adjusting section being provided on a path via which the second ground is electrically connected to the first feeding section.

28. The portable wireless device as set forth in claim 27, wherein:
at least one of the first impedance and the second impedance is a variable impedance.

29. The portable wireless device as set forth in claim 24, wherein:
at least one of the first transmission line and the second transmission line has an arrangement in which an input and an output are high-frequency coupled with each other capacitively.

30. The portable wireless device as set forth in claim 24, wherein:
at least one of the first transmission line and the second transmission line has an arrangement in which an input and an output are connected to each other directly.

31. A portable wireless device comprising:
a first feeding section;
a first ground for providing a reference potential to the first feeding section;
a second feeding section;
a second ground for providing a reference potential to the second feeding section; and
a transmission line having a first terminal and a second terminal,
the first terminal of the transmission line being electrically connected to, via a first branch point provided between the first terminal and the second terminal, both the first feeding section and the first ground,
the second terminal of the transmission line being electrically connected to, via a second branch point provided between the first branch point and the second terminal, both the second feeding section and the second ground.

32. The portable wireless device as set forth in claim 31, further comprising:
a first body;
a second body; and
a body coupling section via which the first body and the second body are coupled with each other,
the first feeding section and the first ground being provided in the first body,
the second feeding section and the second ground being provided in the second body,
the transmission line being provided in the body coupling section,
the first branch point being provided in one of the first body and the body coupling section,
the second branch point being provided in one of the second body and the body coupling section.

33. The portable wireless device as set forth in claim 32, wherein:
the first body and the second body are coupled with each other so as to be rotatable forward and backward by using the body coupling section as an axis of rotation.

34. The portable wireless device as set forth in claim 32, wherein:
the first body and the second body are coupled with each other so as to be slidable with respect to each other by use of the body coupling section provided between the first body and the second body.

35. The portable wireless device as set forth in claim 32, further comprising:
a first impedance adjusting section having a first impedance, the first impedance adjusting section being provided on a path via which the first ground is electrically connected to the first branch point;
a second impedance adjusting section having a second impedance, the second impedance adjusting section being provided on a path via which the first feeding section is electrically connected to the first branch point;
a third impedance adjusting section having a third impedance, the third impedance adjusting section being provided on a path via which the second feeding section is electrically connected to the second branch point; and
a fourth impedance adjusting section having a fourth impedance, the fourth impedance adjusting section being provided on a path via which the second ground is electrically connected to the second branch point.

36. The portable wireless device as set forth in claim 32, wherein:
the first branch point is a first switch for switching a connection of the first terminal of the transmission line between the first feeding section and the first ground; and
the second branch point is a second switch for switching a connection of the second terminal of the transmission line between the second feeding section and the second ground.

37. The portable wireless device as set forth in claim 35, wherein:
at least one of the first impedance, the second impedance, the third impedance, and the fourth impedance is a variable impedance.

38. The portable wireless device as set forth in claim 32, wherein:
the transmission line has an arrangement in which the first terminal and the second terminal are high-frequency coupled with each other capacitively.

39. The portable wireless device as set forth in claim 32, wherein:
the transmission line has an arrangement in which the first terminal and the second terminal are connected to each other directly.

40. The portable wireless device as set forth in claim 24, wherein:
a connection state of at least one of the transmission line(s) is subjected to switching in accordance with a positional relationship between the first body and the second body.

41. The portable wireless device as set forth in claim 24, wherein:
the first feeding section is connected to a first wireless circuit used in a first frequency band;
the second feeding section is connected to a second wireless circuit used in a second frequency band which is different from the first frequency band;
in a case where a difference between a length of the first ground in a short side direction and ¼ of a wavelength of the second frequency band is less than a difference between a length of the second ground in a short side direction and ¼ of a wavelength of the first frequency band, the second feeding section is connected to one of ends of the first ground in the sort side direction; and
in a case where the difference between the length of the first ground in the short side direction and ¼ of the wavelength of the second frequency band is not less than the difference between the length of the second ground in the short side direction and ¼ of the wavelength of first frequency band, the first feeding section is connected to one of ends of the second ground in the short side direction.
